(19) United States
(12) Patent Application Publication
(10) Pub. No.: US 2005/0036015 A1
(43) Pub. Date: Feb. 17, 2005

(54) Liquid container

(76) Inventors: Takeo Seino, Nagano (JP); Hitotoshi Kimura, Nagano (JP)

Correspondence Address: STROOCK & STROOCK & LAVAN LLP, 180 MAIDEN LANE, NEW YORK, NY, 10038, US

(21) Appl. No.: 10/882,528

(22) Filed: Jun. 30, 2004

(30) Foreign Application Priority Data
Aug. 8, 2003 (JP) P2003-290713

(51) Int. Cl. B41J 2/175

(52) U.S. Cl. 347/86

(57) ABSTRACT

An ink cartridge includes a container body with a surface, the surface having a recess, the recess having a bottom and a perimeter wall, and a guide projection disposed within the recess, at least a portion of the guide projection extending from the bottom of the recess toward the surface. Viewing the guide projection in a direction perpendicular to the bottom of the recess, the guide projection has at least three edges. The perimeter wall and the edges of the guide projection define a path therebetween, and the path has at least a predetermined width.

### BACKGROUND OF THE INVENTION

The present invention relates to a liquid container which stores liquid to be supplied to a liquid consuming apparatus therein, and is removably mountable to a container mounting part of the liquid consuming apparatus.

The liquid consuming-apparatus includes, as a representative example thereof, a liquid ejecting apparatus, which ejects a liquid droplet from an ejection head. This liquid ejecting apparatus includes, as a representative example thereof, an ink jet type recording apparatus provided with an ink jet type recording head for recording an image. Other examples of the liquid ejecting apparatus include, for example, an apparatus having color material ejection head used in manufacture of a color filter of a liquid crystal display or the like, an apparatus having an electrode material (conductive paste) ejection head used in electrode formation of an organic EL display, a field emission display (FED) or the like, an apparatus having bioorganic matter ejection head used in biochip manufacture, and an apparatus having a sample ejection head as a precision pipette.

The ink jet type recording apparatus that is representative of the liquid jet apparatus is comparatively less noisy in printing, and can form fine dots with high density. Therefore, the ink jet type recording apparatus is presently used in various printing including color printing.

As a liquid supply system to the liquid consuming apparatus of which the ink jet type recording apparatus is representative, such a system is available, in which the liquid is supplied from a liquid container that stores the liquid therein to the liquid consuming apparatus. Further, in this liquid supply system using the liquid container, the liquid container is generally constituted as a cartridge removably mountable to the liquid consuming apparatus so that a user can exchange the liquid container easily when the liquid in the liquid container is consumed.

Generally, the ink jet type recording apparatus has a carriage that is equipped with a recording head for ejecting an ink droplet and reciprocates along a recording surface of a recording medium. As an ink supply system from the ink cartridge to the recording head, there is a system in which the ink cartridge is mounted on the carriage and the ink is supplied to the recording head from the ink cartridge reciprocating together with the recording head. Further, as another system, there is a system in which the ink cartridge is mounted onto a case or the like of an apparatus body and the ink is supplied through an ink flowing path formed by a flexible tube or the like from the ink cartridge to the recording head.

In any of the above ink supply systems, it is necessary to mount and fix the ink cartridge in a predetermined position of the apparatus body readily and surely. Further, in exchange of the ink cartridge, it is necessary to remove the ink cartridge from the apparatus body readily and surely.

Therefore, the conventional ink jet type recording apparatus and ink cartridge employ, as a mechanism for surely fixing the ink cartridge in the predetermined position of the apparatus body, for example, a mechanism in which the ink cartridge is pressed and fixed by a fixing lever operated after the ink cartridge is inserted into a cartridge holder of the apparatus body.

Patent Reference 1: WO99/59823

However, such cartridge fixing mechanism requires separate steps performed independently, i.e. an insertion step of the ink cartridge into the cartridge holder and a fixing step by operating the fixing lever after insertion, so that the mounting operation of the ink cartridge to the apparatus body is complicated. Further, this conventional cartridge fixing mechanism also requires two-step operation when the ink cartridge is removed.

Further, such a mechanism is conceivable that realizes fixing of the ink cartridge simultaneously with the insertion step during mounting, but even this case requires a step of releasing the fixing when the ink cartridge is removed. This fixing release step must be performed completely independently of a subsequent operation of pulling out the ink cartridge. Therefore, the removing operation of the ink cartridge becomes complicated.

Further, in the conventional ink jet type recording apparatus and ink cartridge, there are those of such constitution that a memory element (IC) storing data such as the kind of ink and the residual ink amount is provided for the ink cartridge, and an apparatus-side contact to be connected to an IC side electrode is provided on the apparatus body side (for example, cartridge holder).

In a case that the ink cartridge having such IC is mounted onto the apparatus body, it is necessary to surely connect the IC-side electrode to the apparatus-side contact when the ink cartridge is mounted to the apparatus body, and further to surely maintain its connection state. Namely, it is necessary to suppress deviation between the apparatus-side contact and the IC-side electrode in a range enabling electric conduction. For example, it is conceivable to make the dimension of the IC-side electrode larger, to thereby make larger a permissible range of the deviation with respect to the apparatus-side contact. However, this results in a problem that the ink cartridge itself is also larger in size with size increase of the IC-side electrode.

The invention has been made in view of the above circumstances, and its object is to provide a liquid container, which can be mounted onto a liquid consuming apparatus readily and surely.

### SUMMARY OF THE INVENTION

To achieve the object, the present invention provides:

An ink cartridge having a container body with a surface, the surface having a recess, the recess having a bottom and a perimeter wall, a guide projection disposed within the recess, at least a portion of the guide projection extending from the bottom of the recess toward the surface, wherein, viewing the guide projection in a direction perpendicular to the bottom of the recess, the guide projection has at least three edges, and wherein the perimeter wall and the edges of the guide projection define a path therebetween, and the path has at least a predetermined width.

In such an ink cartridge, viewing the guide projection in a direction perpendicular to the bottom of the recess, the guide projection can have a generally-triangular shape with three vertexes.

Also, in such an ink cartridge, viewing the guide projection in a direction perpendicular to the bottom of the recess, at least one of the vertexes can include an outward-extending projection.

This ink cartridge can have a portion of the perimeter wall with a projection arranged so that the predetermined width of the path is maintained between the projection and the outward-extending projection.

Additionally, in the ink cartridge, viewing the guide projection in a direction perpendicular to the bottom of the recess, the projection can extend toward the guide projection.

The ink cartridge can be designed so that the path defines a loop.

For a further aspect of this invention, an ink cartridge has a container body with a surface, the surface having a recess, the recess having a bottom, and a perimeter wall, a guide projection disposed within the recess, and at least a portion of the guide projection extending from the bottom of the recess toward the surface. The perimeter wall and the guide projection define a path therebetween, the path having a flat first floor section leading to a sloped second floor section leading to a flat third floor section leading to a sloped fourth floor section leading to a flat fifth floor section.

In such an ink cartridge the flat first, third and fifth floor sections can lie in parallel planes.

Also, in that ink cartridge, the flat first floor section and the sloped second floor section can be disposed along a first line, and the flat third floor section can be approximately disposed along a second line, and the first and second lines intersect. The ink cartridge can be arranged so that the sloped fourth floor section and the flat fifth floor section are disposed along a third line, and the second and the third lines intersect.

Additionally, the intersecting first, second and third lines can define a triangle.

The ink cartridge also can be arranged so that the second and third lines intersect at a right angle.

In the ink cartridge the path can define a loop.

A further embodiment of this invention involves an ink cartridge with a container body having a front surface having a first opening extending inward into the ink cartridge along a first line and a second opening extending inward into the ink cartridge along a second line approximately parallel to the first line, and a bottom surface, the bottom surface having a recess, the recess having a bottom and a perimeter wall, and a guide projection disposed with in the recess, at least a portion of the guide projection extending from the bottom of the recess toward the bottom surface. Viewed in a direction perpendicular to the front surface, the first and the second lines lie in a plane parallel to at least a portion of the bottom surface and at least a portion of the bottom of the recess is parallel to the plane.

Such an ink cartridge can be arranged so that, viewed in the direction perpendicular to the front surface, the front surface has an open section leading to the recess, the first opening is located closer to the open section than the second opening, the open section of the front surface has two vertical edges, the vertical edges lie in parallel first and second vertical planes, and the open section is positioned so that at least a part of the first opening is disposed between the parallel first and second vertical planes.

Additionally, in this ink cartridge, when viewed in the direction perpendicular to the front surface, the first line can be disposed between the parallel first and second vertical planes.

Still another embodiment of this invention is directed to an ink cartridge with a container body having a front surface having a first opening extending inward into the ink cartridge along a first line and a second opening extending inward into the ink cartridge along a second line approximately parallel to the first line, and a bottom surface, the bottom surface having a recess, the recess having a bottom and a perimeter wall, and a guide projection disposed within the recess, at least a portion of the guide projection extending from the bottom of the recess toward the bottom surface. When viewed in a direction perpendicular to the front surface, the first and the second openings lie in a plane parallel to at least a portion of the bottom surface and at least a portion of the bottom of the recess is parallel to the plane.

Such an ink cartridge can be designed so that the guide projection and the perimeter wall define a path therebetween, and the path defines a loop.

A further embodiment of the invention is an ink cartridge with a generally-rectangular container body having an interior and a bottom surface, the bottom surface having a recess, the recess having a bottom and a perimeter wall, a front surface and a side surface, the bottom surface, the front surface and the side surface lying in respective intersecting perpendicular planes, and a guide projection disposed within the recess. At least a portion of the guide projection extend from the bottom of the recess toward the surface so that, viewing the guide projection in a direction perpendicular to the bottom of the recess, the guide projection has at least three edges. An ink supply port communicates with the interior of the container body, the ink supply port being located in the front surface, and an air opening is in fluid communication with the interior of the container, the air opening being located in the front surface. A first positioning hole and a second positioning hole are provided, the first and second positioning holes being located in the front surface, and the perimeter wall and the edges of the guide projection define a path therebetween, and the path has at least a predetermined width.

In this ink cartridge the recess and one of the first and the second positioning holes are located proximate to a corner defined by the intersecting perpendicular planes.

The ink cartridge can also have a memory device having an electrode, the memory device being mounted on the side surface.

In the ink cartridge, the memory device, the recess and one of the first and the second positioning holes can be located proximate to a corner defined by the intersecting perpendicular planes.

Moreover, the ink cartridge can include a grooved section located on the bottom surface, the grooved section having an arrangement of grooves that identifies a property of the ink cartridge.

The ink cartridge also can have a grooved section located on the bottom surface, the grooved section having an arrangement of grooves that identifies a property of the ink cartridge, and wherein, viewing the ink cartridge in a direction perpendicular to the bottom surface, imaginary extensions of the grooved section and the recess respectively overlap the first and the second positioning holes.

Optionally, in the ink cartridge, viewing the guide projection in a direction perpendicular to the bottom of the recess, the guide projection can have a generally-triangular shape with three vertexes.

The ink cartridge can be arranged so that, viewing the guide projection in a direction perpendicular to the bottom of the recess, at least one of the vertexes includes an outward-extending projection.

In the ink cartridge, a portion of the perimeter wall can have a projection arranged so that the predetermined width of the path is maintained between the projection and the outward-extending projection.

Also, the cartridge can be arranged so that, viewing the guide projection in a direction perpendicular to the bottom of the recess, the projection extends toward the guide projection.

In the ink cartridge the path may define a loop.

Another embodiment is an ink cartridge with a generally-rectangular container body having an interior and a bottom surface, the bottom surface having a recess, the recess having a bottom and a perimeter wall, a front surface and a side surface, the bottom surface, the front surface and the side surface lying in respective intersecting perpendicular planes, and a guide projection disposed within the recess, at least a portion of the guide projection extending from the bottom of the recess toward the surface. An ink supply port communicates with the interior of the container body, the ink supply port being located in the front surface, an air opening is in fluid communication with the interior of the container, the air opening being located in the front surface, and a first positioning hole and a second positioning hole are provided, the first and second positioning holes being located in the front surface. The perimeter wall and the guide projection define a path therebetween, the path having a flat first floor section leading to a sloped second floor section leading to a flat third floor section leading to a sloped fourth floor section leading to a flat fifth floor section.

In such an ink cartridge the recess and one of the first and the second positioning holes can be located proximate to a corner defined by the intersecting perpendicular planes.

The ink cartridge can also have a memory device with an electrode, the memory device being mounted on the side surface.

Also, in the ink cartridge the memory device, the recess and one of the first and the second positioning holes can be located proximate to a corner defined by the intersecting perpendicular planes.

The ink cartridge can include a grooved section located on the bottom surface, the grooved section having an arrangement of grooves that identifies a property of the ink cartridge.

This ink cartridge can also have a grooved section located on the bottom surface, the grooved section having an arrangement of grooves that identifies a property of the ink cartridge. Viewing the ink cartridge in a direction perpendicular to the bottom surface, imaginary extensions of the grooved section and the recess can respectively overlap the first and the second positioning holes.

Optionally, in the ink cartridge the flat first, third and fifth floor sections can lie in parallel planes.

In addition, the flat first floor section and the sloped second floor section can be disposed along a first line, and the flat third floor section can be approximately disposed along a second line, and the first and second lines can intersect.

For this ink cartridge the sloped fourth floor section and the flat fifth floor section can be disposed along a third line, and the second and the third lines intersect.

In this ink cartridge the path can define a loop.

The ink cartridge may be arranged so that the intersecting first, second and third lines define a triangle.

In this ink cartridge, the first and second lines may intersect at a right angle.

One embodiment of this invention has an ink cartridge with a generally-rectangular container body having an interior, a bottom surface, the bottom surface having a recess, the recess having a bottom and a perimeter wall, a front surface having a first opening extending inward into the ink cartridge along a first line and a second opening extending inward into the ink cartridge along a second line approximately parallel to the first line, and a side surface, the bottom surface, the front surface and the side surface lying in respective intersecting perpendicular planes. A guide projection is disposed within the recess, and at least a portion of the guide projection extends from the bottom of the recess toward the bottom surface. Viewed in a direction perpendicular to the front surface, the first and the second lines lie in a plane parallel to at least a portion of the bottom surface and at least a portion of the bottom of the recess is parallel to the plane.

Such an ink cartridge can have the recess and one of the first and the second positioning holes be located proximate to a corner defined by the intersecting perpendicular planes.

The ink cartridge can also have a memory device with an electrode, the memory device being mounted on the side surface.

The memory device, the recess and one of the first and the second positioning holes can be located proximate to a corner defined by the intersecting perpendicular planes.

Also, the ink cartridge could have a grooved section located on the bottom surface, the grooved section having an arrangement of grooves that identifies a property of the ink cartridge.

The ink cartridge could include a grooved section located on the bottom surface, the grooved section having an arrangement of grooves that identifies a property of the ink cartridge so that, viewing the ink cartridge in a direction perpendicular to the bottom surface, imaginary extensions of the grooved section and the recess respectively overlap the first and the second positioning holes.

In this ink cartridge, when it is viewed in the direction perpendicular to the front surface, the front surface can have an open section leading to the recess, the first opening can be located closer to the open section than the second opening, the open section of the front surface can have two vertical edges, the vertical edges lying in parallel first and second vertical planes, and the open section can be positioned so that at least a part of the first opening is disposed between the parallel first and second vertical planes.

Further, in the ink cartridge, viewed in the direction perpendicular to the front surface, the first line can be disposed between the parallel first and second vertical planes.

Yet another embodiment of this invention is directed to an ink cartridge with a generally-rectangular container body having an interior, a front surface having a first opening extending inward into the ink cartridge along a first line and a second opening extending inward into the ink cartridge along a second line approximately parallel to the first line, and a bottom surface, the bottom surface having a recess, the recess having a bottom and a perimeter wall, the bottom surface, the front surface and the side surface lying in respective intersecting perpendicular planes. A guide projection is disposed within the recess, and at least a portion of the guide projection extends from the bottom of the recess toward the bottom surface. Viewed in a direction perpendicular to the front surface, the first and the second openings lie in a plane parallel to at least a portion of the bottom surface and at least a portion of the bottom of the recess is parallel to the plane.

This ink cartridge can be arranged so that the recess and one of the first and the second openings are located proximate to a corner defined by the intersecting perpendicular planes.

Also, the ink cartridge can include a memory device having an electrode, the memory device being mounted on the side surface.

Such an ink cartridge can be arranged so that the memory device, the recess and one of the first and the second openings are located proximate to a corner defined by the intersecting perpendicular planes.

The ink cartridge can also include a grooved section located on the bottom surface, the grooved section having an arrangement of grooves that identifies a property of the ink cartridge.

In the ink cartridge, there also can be provided a grooved section located on the bottom surface, the grooved section having an arrangement of grooves that identifies a property of the ink cartridge, and wherein, viewing the ink cartridge in a direction perpendicular to the bottom surface, imaginary extensions of the grooved section and the recess respectively overlap the first and the second openings.

Additionally, in the ink cartridge the guide projection and the perimeter wall can define a path therebetween, and the path defines a loop.

Yet another aspect of this invention is an ink cartridge with a generally-rectangular container body having an interior and a bottom surface, the bottom surface having a recess, the recess having a bottom surface and a perimeter wall, a front surface and a side surface, the bottom surface, the front surface and the side surface lying in respective intersecting perpendicular planes, a guide projection disposed within the recess, at least a portion of the guide projection extending from the bottom of the recess toward the surface, wherein, viewing the guide projection in a direction perpendicular to the bottom surface of the recess, the guide projection has at least first, second and third edges. The ink cartridge also has an ink supply port communicating with the interior of the container body, the ink supply port being located in the front surface, a first positioning hole and a second positioning hole, the first and second positioning holes being located in the front surface so that the ink supply port is located between the first and second positioning holes, and a memory device having an electrode, the memory device being mounted on the side surface. The recess, the memory device and one of the first and second positioning-holes are located proximate to a corner defined by the intersecting perpendicular planes. Also, the perimeter wall and the edges of the guide projection define a path therebetween, the path including an entrance-side guide part, an intermediate guide part, a fixing part, and an exit-side guide part, and the entrance-side guide part is defined at least in part by the first edge of the guide projection, the first edge of the guide projection being inclined relative to the front and side surfaces and perpendicular to the bottom surface. The intermediate guide part is defined at least in part by first and second portions of the perimeter wall, the first portion of the perimeter wall being perpendicular to the side and bottom surfaces and parallel to the front surface, the second portion of the perimeter wall extending from the first portion of the perimeter wall toward the second edge of the guide projection, and being perpendicular to the bottom and front surfaces and parallel to the side surface. The fixing part is defined at least in part by first and second portions of the second edge of the guide projection, the first portion of the second edge being perpendicular to the side and bottom surfaces and parallel to the front surface, the second portion of the second edge extending outwardly from the first portion of the second edge and being perpendicular to the bottom and front surfaces and parallel to the side surface. The exit-side guide part is defined at least in part by third and fourth portions of the perimeter wall, the third portion of the perimeter wall being perpendicular to the bottom and side surfaces and parallel to the front surface, the fourth portion of the perimeter wall extending from the third portion of the perimeter wall along the third edge of the guide projection and being perpendicular to the bottom and front surfaces and parallel to the side wall. An end of the entrance side guide part and an end of the exit-side guide part are connected together by a step.

In another embodiment, this invention involves an ink cartridge mountable to a mounting part of an ink jet recording apparatus, the mounting part including a fixing pin, a first biasing member for applying a first biasing force to the pin in a first direction, and a second biasing member for applying a second biasing force to the ink cartridge, inserted into the mounting part in an insertion direction, in a second direction opposite from the insertion direction and perpendicular to the first direction. Such an ink cartridge includes a generally-rectangular container body having an interior and a bottom surface, the bottom surface having a recess, the recess having a bottom surface and a perimeter wall, a front surface and a side surface, the bottom surface, the front surface and the side surface lying in respective intersecting perpendicular planes, a guide projection disposed within the recess, at least a portion of the guide projection extending from the bottom of the recess toward the surface, wherein, viewing the guide projection in a direction perpendicular to the bottom surface of the recess, the guide projection has at least first, second and third edges, and an ink supply port communicating with the interior of the container body, the ink supply port being located in the front surface. Also, the ink cartridge has a first positioning hole and a second positioning hole, the first and second positioning holes being located in the front surface so that the ink supply port is located between the first and second positioning holes, and a memory device having an electrode, the memory device being mounted on the side surface. The recess, the memory device and one of the first and second positioning holes are located proximate to a corner defined by the intersecting perpendicular planes, the perimeter wall and the edges of the guide projection define a path therebetween for permitting the pin to pass therethrough, the path including an entrance-side guide part, an intermediate guide part, a fixing part, and an exit-side guide part, and the entrance-side guide part is defined at least in part by the first edge of the guide projection, the first edge of the guide projection being for guiding the pin against the first biasing force when the ink cartridge is inserted into the mounting part against the second biasing force, and the intermediate guide part is defined at least in part by first and second portions of the perimeter wall, the first portion of the perimeter wall being for defining a first fully inserted position of the ink cartridge upon contact with the pin when the ink cartridge is inserted into the mounting part against the second biasing force, the second portion of the perimeter wall being for stopping the pin against the first biasing force when the ink cartridge is positioned at the first fully inserted position. Also, the fixing part is defined at least in part by first and second portions of the second edge of the guide projection, the first portion of the second edge being for holding the ink cartridge against the second biasing force upon contact with the pin when the ink cartridge is moved from the first fully inserted position to a predetermined fixing position by the second biasing force, the second portion of the second edge being for holding the pin against the first biasing force when the ink cartridge is moved from the first fully inserted position to the predetermined fixing position by the second biasing force, and the exit-side guide part is defined at least in part by third and fourth portions of the perimeter wall, the third portion of the perimeter wall being for defining a second fully inserted position of the ink cartridge upon contact with the pin when the ink cartridge is moved from the predetermined fixing position against the second biasing force, the fourth portion of the perimeter wall being for guiding the pin against the first biasing force and for moving the ink cartridge from the second fully inserted position using the second biasing force. An end of the entrance side guide part and an end of the exit-side guide part are connected together by a step for preventing the pin from directly entering into the exit-side guide part and for guiding the pin into the entrance side guide part.

The present disclosure relates to the subject matter contained in Japanese patent application No. 2003-290713 filed on Aug. 8, 2003, which is expressly incorporated herein by reference in its entirety.

### BRIEF DESCRIPTION OF THE DRAWINGS

FIG. 1 is a perspective view showing an ink cartridge according to one embodiment of the invention and a cartridge mounting part of an ink jet type recording apparatus to which this ink cartridge is mounted.

FIGS. 2A to 2D are diagrams showing the ink cartridge according to the embodiment of the invention, in which FIG. 2A is a plan view, FIG. 2B is a side view, FIG. 2C is a rear view, and FIG. 2D is a front view.

FIGS. 3A and 3B are diagrams showing the ink cartridge according to the embodiment of the invention, in which FIG. 3A is a bottom view, and FIG. 3B is a side view.

FIGS. 4A to 4D are perspective views showing the ink cartridge according to the embodiment of the intention, in which FIG. 4A is a diagram viewed in a direction where a diagonally upward back surface can be seen, FIG. 4B is a diagram viewed in a direction where a diagonally downward front surface can be seen, FIG. 4C is a diagram viewed in a direction where a diagonally downward back surface can be seen, and FIG. 4D is a diagram viewed in a direction where a diagonally upward front surface can be seen.

FIG. 5 is an exploded perspective view of the ink cartridge according to the embodiment of the invention.

FIGS. 6A to 6D are diagrams showing a state in which a lid member is removed from the ink cartridge according to the embodiment of the invention, in which FIG. 6A is a plan view in a state where an ink bag is housed, FIG. 6B is a front view of FIG. 6A, FIG. 6C is a plan view in a state where the ink bag is not housed, and FIG. 6D is a front view of FIG. 6C.

FIG. 7 is a plan view showing a state where the ink cartridge according to the embodiment of the invention is mounted to the cartridge mounting part of the ink jet type recording apparatus so as to show the apparatus inside.

FIG. 8 is a perspective view showing the state where the ink cartridge according to the embodiment of the invention is mounted to the cartridge mounting part of the ink jet type recording apparatus so as to show the apparatus inside.

FIG. 9 is a plan view showing the cartridge mounting part of the ink jet type recording apparatus shown in FIG. 7 in a state where the ink cartridge has not been mounted yet so as to show the apparatus inside.

FIG. 10 is a perspective view showing the cartridge mounting part of the ink jet type recording apparatus shown in FIG. 8 in the state where the ink cartridge has not been mounted yet so as to show the apparatus inside.

FIG. 11A is a top plan view showing the state where the ink cartridge according to the embodiment of the invention is mounted to the cartridge mounting part of the ink jet type recording apparatus so as to show the apparatus inside, and FIG. 11B is a side cross-sectional view taken along a line b-b in FIG. 11A.

FIG. 12 is a top plan view showing the cartridge mounting part of the ink jet type recording apparatus shown in FIG. 7 in a state where a slider is removed so as to show the apparatus inside.

FIG. 13 is a perspective view showing the cartridge mounting part of the ink jet type recording apparatus shown in FIG. 8 in the state where the slider is removed so as to show the apparatus inside.

FIGS. 14A and 14B are enlarged perspective views of a turn lever member of the cartridge mounting part shown in FIGS. 12 and 13, in which FIG. 14A is a diagram viewed from a diagonal upside, and FIG. 14B is a diagram viewed from a diagonal downside.

FIGS. 15A and 15B are enlarged views of the ink cartridge according to the embodiment of the invention, in which FIG. 15A is a bottom plan view showing a rear surface of a front-end part, and FIG. 15B is a front elevational view showing a front surface.

FIGS. 16A to 16C are diagrams illustrating the depth and shape of a guide groove of the ink cartridge according to the embodiment of the invention, in which FIG. 16A is a bottom plan view of the ink cartridge, FIG. 16B is a cross-sectional view taken along a line b-b in FIG. 16A, and FIG. 16C is a cross-sectional view taken along a line c-c in FIG. 16A.

FIG. 17 is a diagram showing the motion of a fixing pin along a guide groove when the ink cartridge according to the embodiment of the invention is mounted and removed.

### DESCRIPTION OF THE PREFERRED EMBODIMENT

As an embodiment of a liquid container according to the invention, an ink cartridge for an ink jet type recording apparatus will be described with reference to drawings.

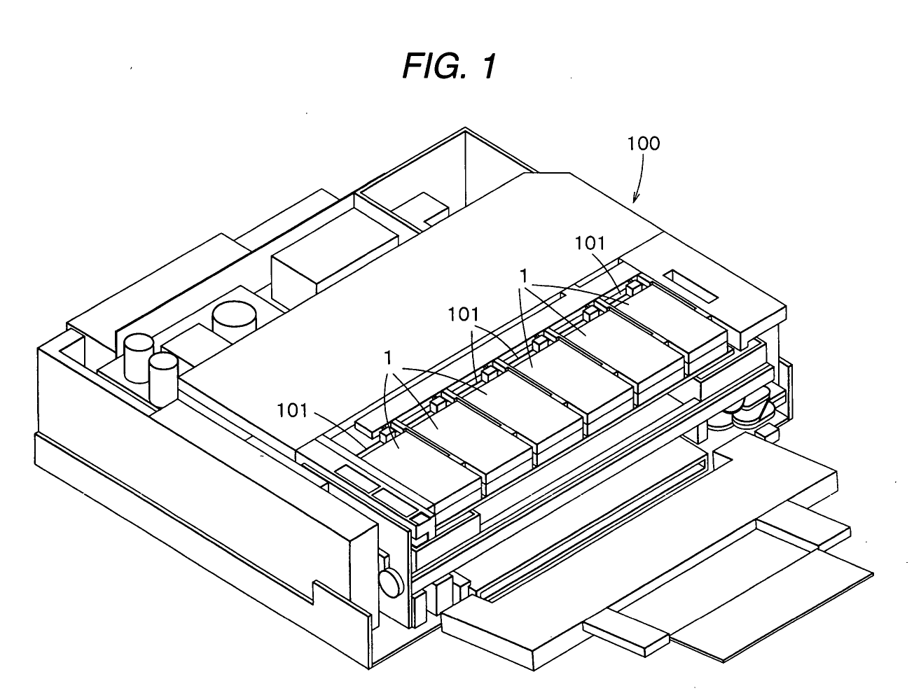

FIG. 1 is a perspective view showing several ink cartridges 1 according to the embodiment and a cartridge mounting part 101 of an ink jet type recording apparatus to which these ink cartridges 1 are mounted. In this example, six cartridge mounting parts 101 are provided for the ink jet type recording apparatus 100, and each cartridge mounting part 101 is opened on a front surface of the ink jet type recording apparatus 100. Further, the six cartridge mounting parts 101 are arranged adjacent to each other along a line on the same horizontal plane, and the six ink cartridges are arranged in a flat manner and adjacent to each other along a line.

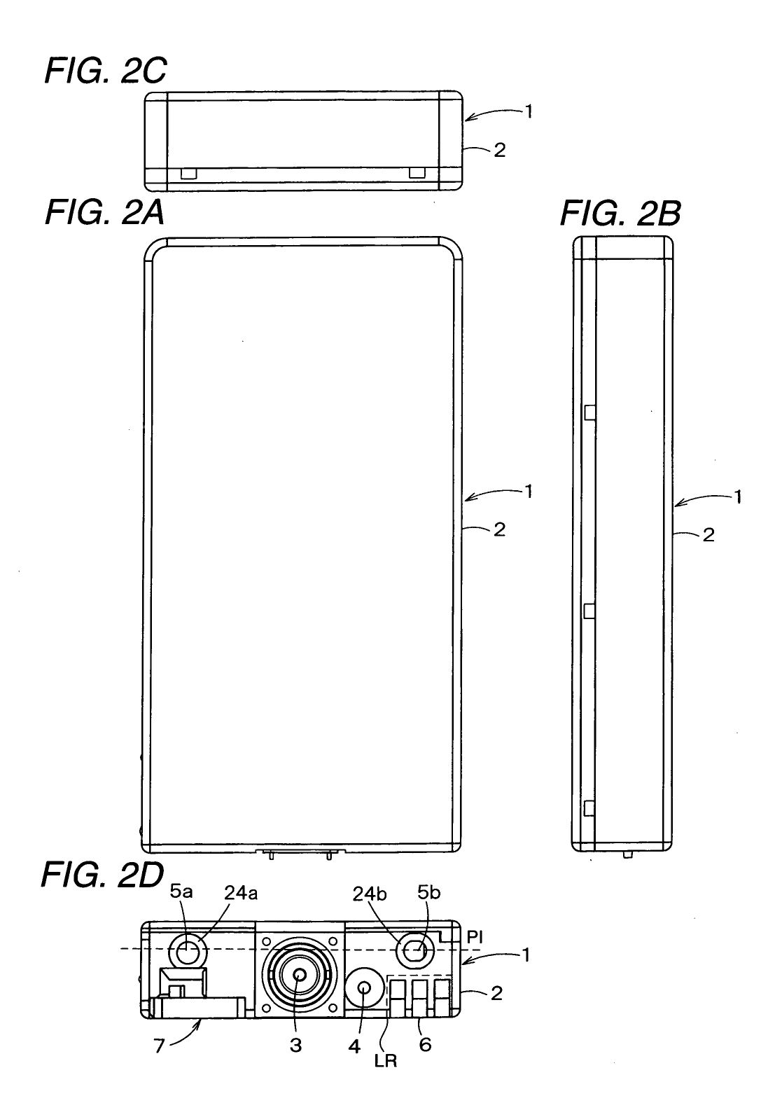

FIGS. 2 to 4 are diagrams respectively showing an exterior shape of one ink cartridge 1. The ink cartridge 1 has a container body 2 formed approximately in the shape of a rectangular parallelepiped, and an ink supply port 3 from which ink is fed out to the ink jet type recording apparatus 100 is formed at a front surface of this container body 2.

In other words, the ink cartridge's container body is generally rectangular, meaning it is a structure having walls at least part of which lie in X, Y and Z planes. The present invention therefore contemplates variant structures such as cartridge bodies where one or more corners are clipped off, or portions of the flat walls are curved or lie in other planes.

Likewise, the term “proximate to a corner”: is used generally, and covers the positioning of a structure relative to a corner where some benefit is derived by virtue of the proximity of the structure to that corner.

Positional terms like “top” and “bottom” are relative, and depend upon the orientation of the ink cartridge. Thus, what is a top surface would become the bottom surface, upon inversion of the cartridge.

Further, the front surface of the container body 2 also includes a pressure fluid inlet 4 through which pressure fluid for pressurizing ink inside the container body 2 and feeding-out the ink from the ink supply port 3 is introduced into the container body 2.

Further, a pair of positioning holes 5a and 5b into which a pair of positioning projections provided at the cartridge mounting part 101 are inserted is formed on the front surface of the container body 2. Around the pair of positioning holes 5a and 5b are formed cartridge-side positioning surfaces 24a and 24b, which are brought into contact with apparatus-side positioning surfaces of the cartridge mounting part 101 so as to perform positioning in the inserting direction of the ink cartridge 1. The pair of positioning holes 5a and 5b and the pair of cartridge-side positioning surfaces 24a and 24b constitute a cartridge-side positioning part.

In this embodiment, openings of the ink supply port 3, pressure fluid inlet 4 and positioning holes 5a, 5b extend into the ink cartridge 1 along respective lines (axes) which are parallel to one another. Further, as shown in FIG. 2D, the openings of the positioning holes 5a, 5b and the central axes thereof lie in a plane P1 parallel to a bottom surface of the container body 2.

Further, an erroneous mount preventing structure 6 is provided at a corner of the container body 2 including the front surface, that is, at a corner on the opposite side to a cartridge-side fixing structure 7 side in relation to the ink supply port 3. This erroneous mount preventing structure 6 has such a shape as to properly mount a predetermined ink kind of ink cartridge 1 to a predetermined position when the ink cartridge 1 is attached to the ink jet type recording apparatus 100, and to prevent mounting of any cartridge that is not the proper ink type of ink cartridge.

By way of non-limiting example, the erroneous mount preventing structure 6 could have a number of grooves whose length, width and/or depth correspond to the color or type of ink which the ink cartridge contains. Yellow, magenta, cyan and black cartridges would all have different groove arrangements, thereby preventing mis-insertion of a cartridge in an incorrect printer receptacle.

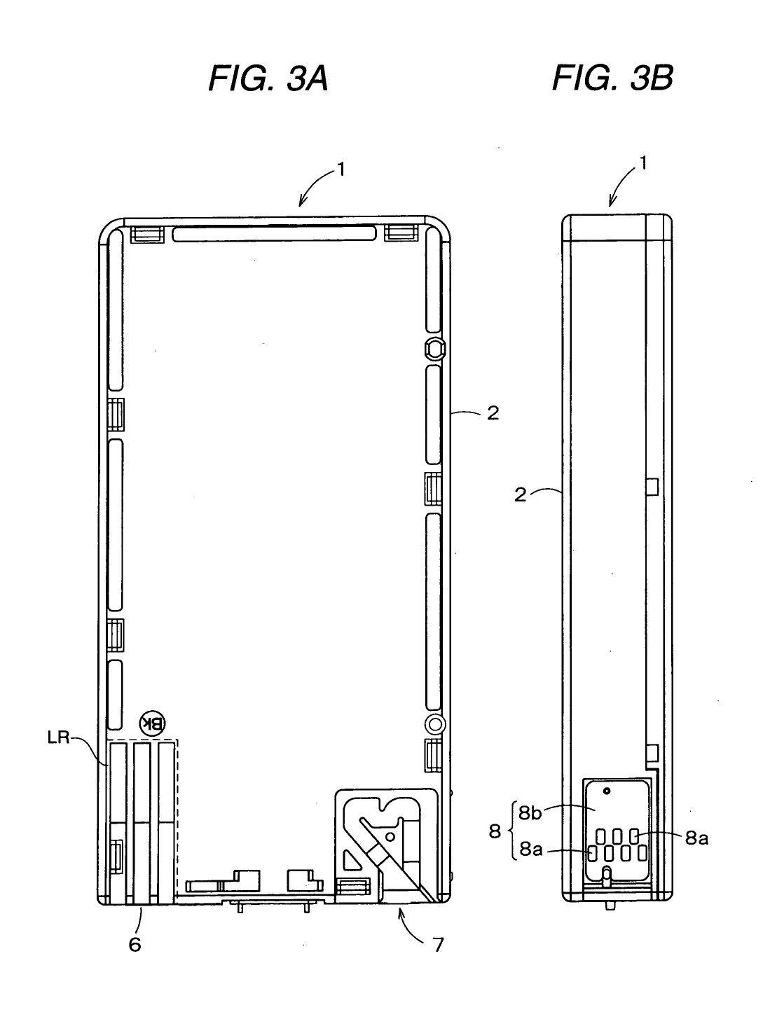

In addition, if a user can surely identify the property of the ink cartridge and a proper mount position for the ink cartridge, the erroneous mount prevention structure 6 may be omitted. In this case, in place of the structure 6, a large recess having a simple rectangular parallelopipedal shape may be provided as illustrated by a dotted letter LR in FIGS. 2D and 3A, which large recess is shaped and dimensioned to accept reception of all identification projections disposed on the cartridge mounting part 101.

Further, on a rear surface (bottom surface) of the container body 2, at the corner on the opposite side to the corner where the erroneous mount preventing structure 6 is provided, the cartridge-side fixing structure 7 is provided adjacent to the front surface of the container body 2. This cartridge-side fixing structure 7, when the ink cartridge 1 is mounted to the container mounting part 101, regulates the movement of the ink cartridge 1 in the pulling direction so as to control insertion to and removal from the ink jet type recording apparatus.

Though the cartridge-side fixing structure 7 is provided on the rear surface of the container body 2 in this embodiment, the cartridge-side fixing structure 7 is not to be limited in position to the rear surface of the container body 2 but can be located elsewhere, for example, on the upper surface of the container body 2.

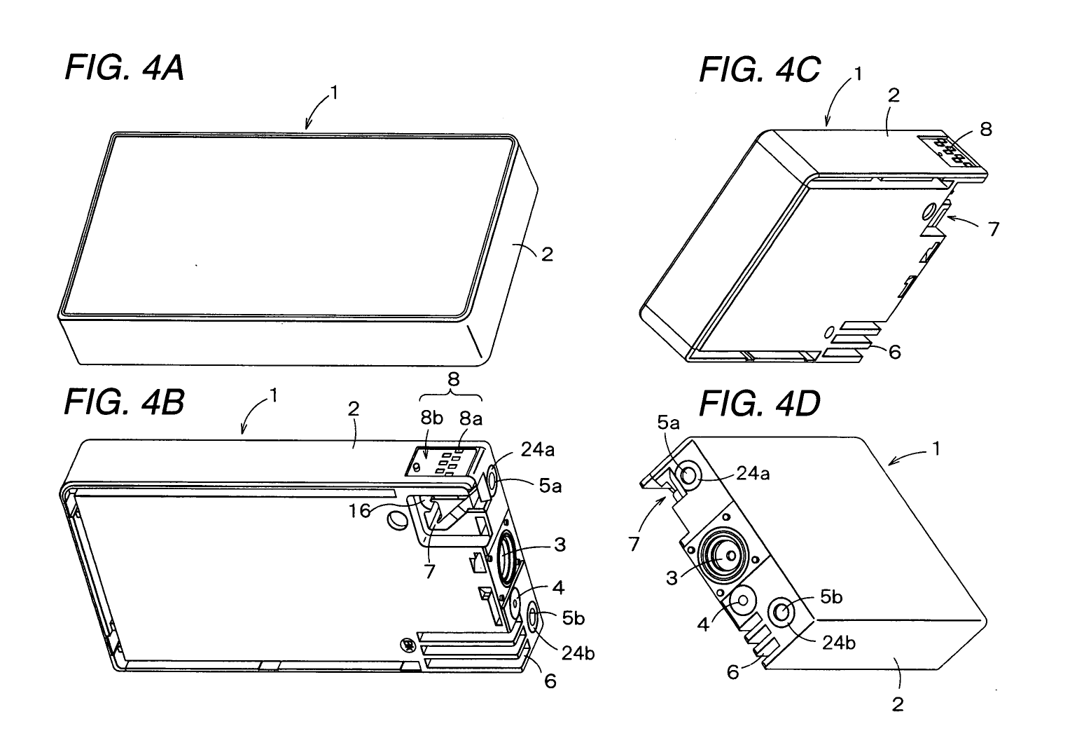

Further, as depicted in FIG. 3(b), on one side surface of the container body 2, near the cartridge-side fixing structure 7, a circuit board 8b equipped with an IC (semiconductor memory element) which stores data such as the kind of ink and the residual ink amount in the container is provided. On a surface of this circuit board 8b, an electrode (cartridge-side electrode) 8a which is electrically connected to the IC and comes into contact with an apparatus-side contact of the recording apparatus body is provided, and the circuit board 8b and the electrode 8a constitute a memory unit 8. The memory unit 8 is arranged at a position near the ink supply port 3 of the container body 2 as well as the cartridge-side fixing structure 7. Though the memory element and the electrode 8 depicted in FIG. 4b are formed on the circuit board 8b in the embodiment, this structure is by example only and not limitation and other constructions could be used—for instance, the memory element and the electrode 8a can be formed on a flexible printed circuit and arranged at different positions on the container body 2.

More preferably, the memory element can be located near the same corner by which the cartridge-side fixing structure 7 and one of the positioning holes 5a are formed. Such an arrangement allows for very precise positioning of all these cartridge structures.

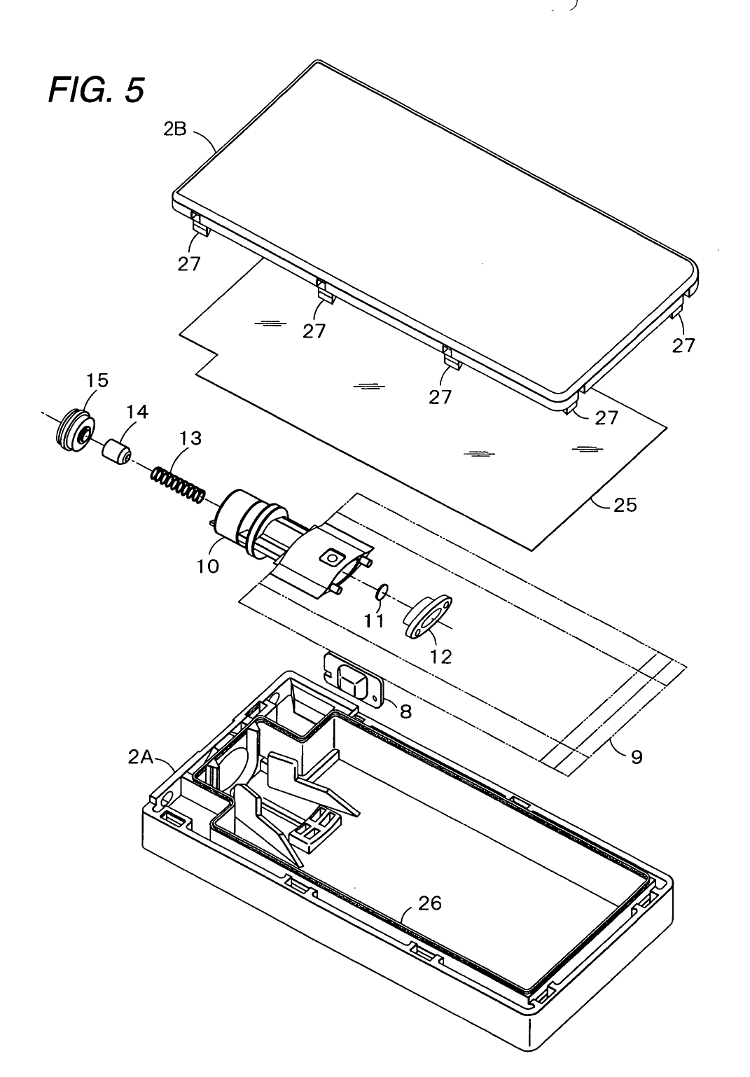

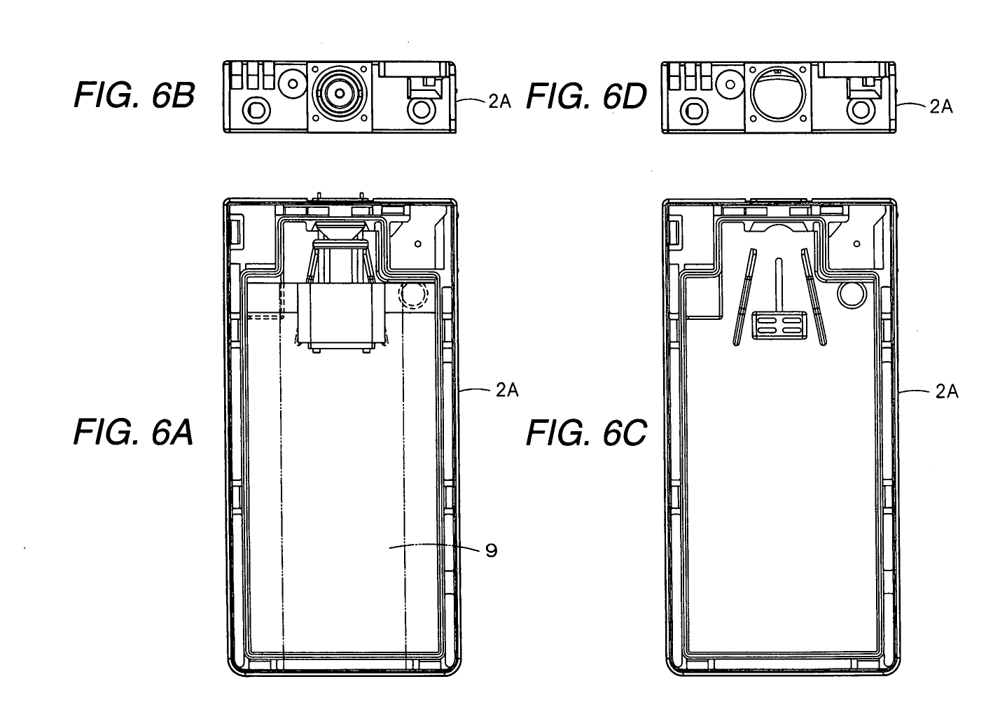

FIG. 5 is an exploded perspective view showing that the ink cartridge 1, and the container body 2 includes a case body 2A of which an upper surface is opened, and a lid member 2B seals the open upper surface of this case body 2A. FIG. 6 shows a state where the lid member 2B is removed from the ink cartridge 1.

As shown in FIGS. 5 and 6, an ink bag 9 having a flexible ink storing part (shown by broken lines for description) that is filled with ink is housed inside the container body 2. The ink bag 9 is affixed to a port part 10 through which the ink stored inside the ink bag 9 can be supplied to the outside. At an inside end part of this port part 10, a check valve 11 is arranged inside and a cap 12 is attached onto the check valve 11. On the other hand, at an outside end part of the port part 10, a spring seat 14 urged by a spring 13 is arranged inside and a seal supply cap 15 is attached.

A film 25 is fixed by heat-welding to a welding border 26, which is formed to surround the periphery of the region of the case body 2A in which the ink bag 9 is housed, thereby to make the inside of the case body 2A into closed space. This closed space is arranged so that the pressurized fluid (pressurized air in this embodiment) introduced from the pressure fluid inlet 4 is contained tightly and does not leak to the outside, and the ink storing part of the ink bag 9 is pressed by the pressurized fluid so that ink can be supplied to the outside. Further, the lid member 2B is fixed to the case body 2A by engagement projections 27 formed in the lid member 2B so as to cover the film 25 thereby to protect the film 25 and prevent useless expansion of the film 25 in the pressurizing time.

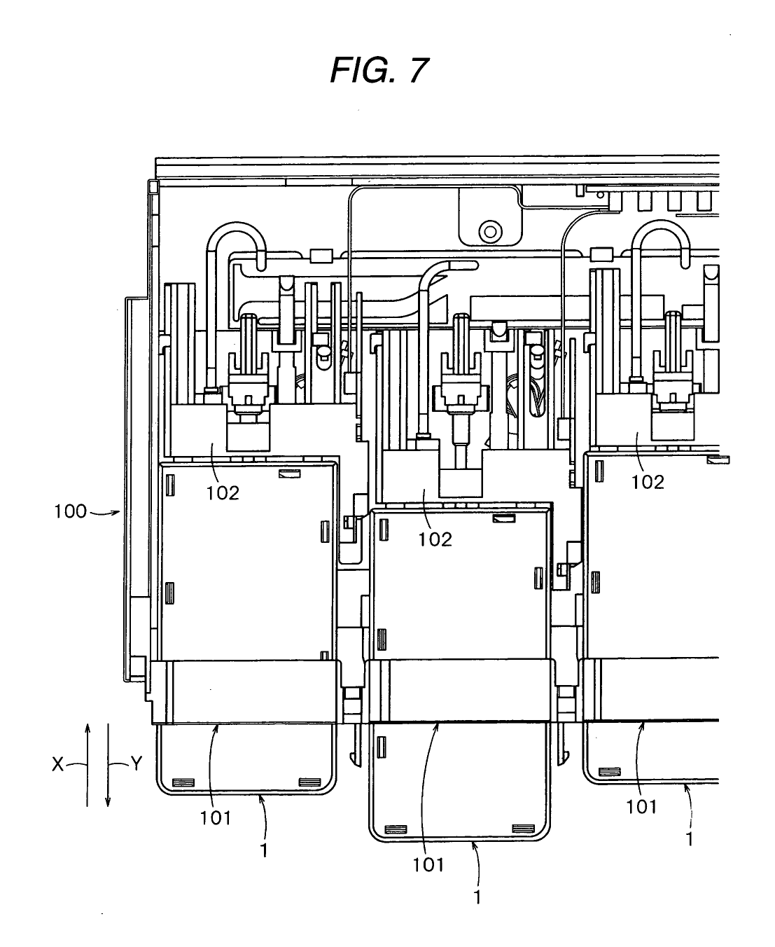

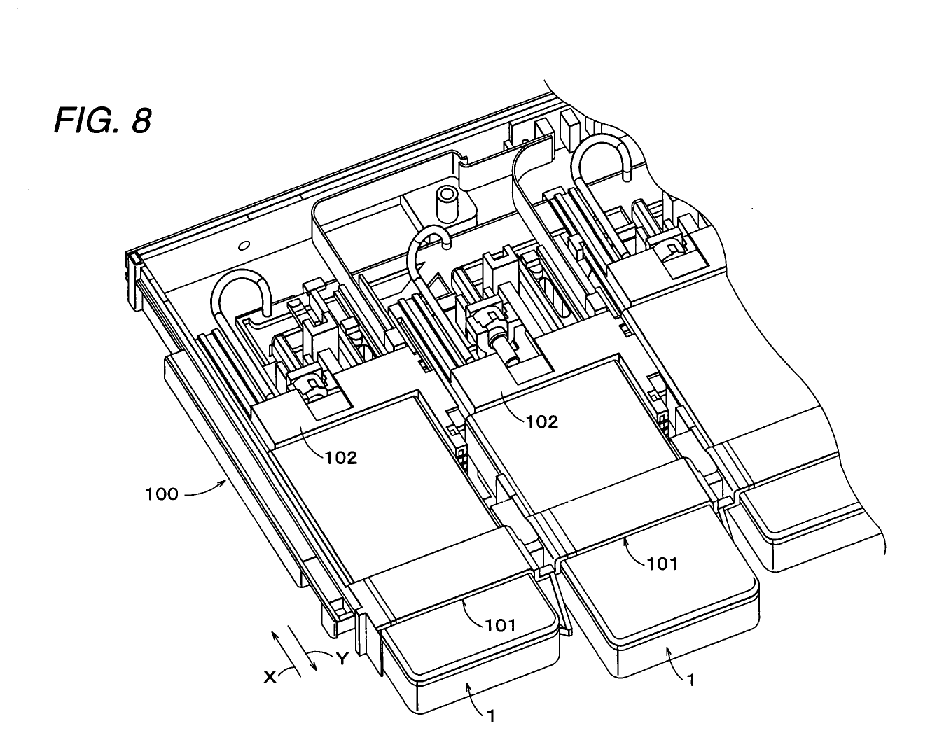

FIGS. 7 and 8 show respectively a state where the ink cartridges 1 are mounted to the cartridge mounting parts 101 of the ink jet type recording apparatus 100. For the cartridge mounting part 101, a slider member 102 to which the front surface part of the ink cartridge 1 is connected is provided. This slider member 102 is provided slidably in the inserting and pulling (removing) directions of the ink cartridge 1, and urged by a spring unit in a direction (pulling direction y) opposite to the inserting direction X of the ink cartridge 1.

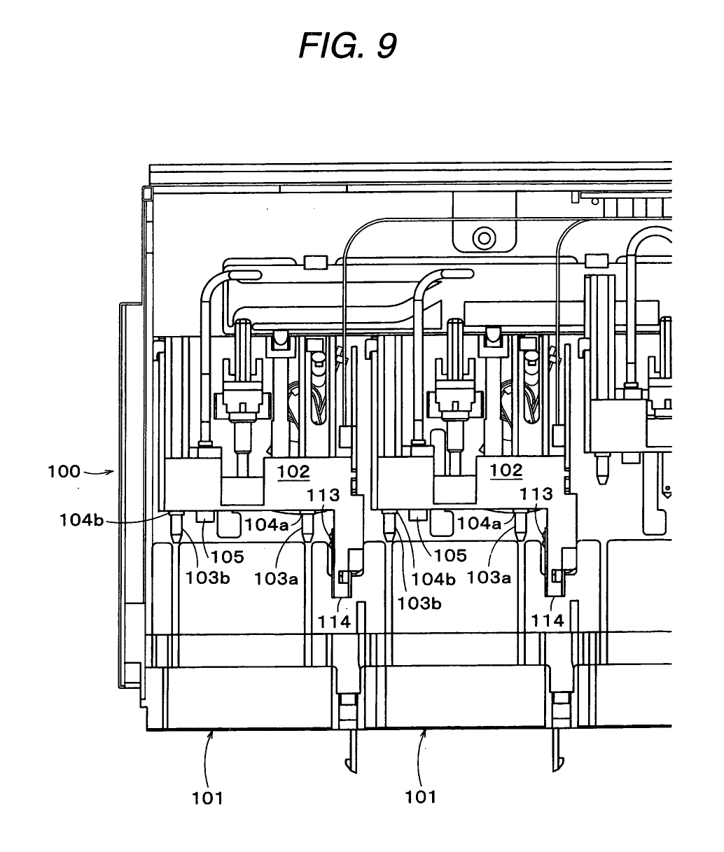

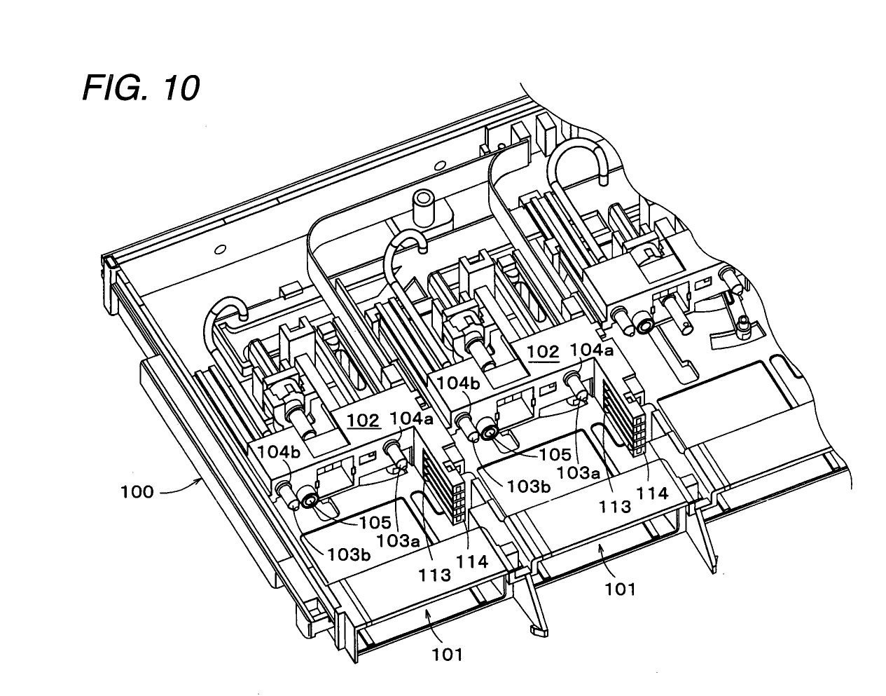

FIGS. 9 and 10 show respectively the cartridge mounting part 101 in the state where the cartridge 1 is not mounted to the cartridge mounting part 101. A pair of positioning projections 103a and 103b are provided by a surface of the slider member 102 opposed to the ink cartridge front surface. For each base part of each positioning projection 103a, 103b, an apparatus-side positioning surface 104a, 104b is provided by each shoulder part. The pair of positioning projections 103a, 103b and the pair of apparatus-side positioning surfaces 104a, 104b constitute an apparatus-side positioning part.

When the ink cartridge 1 is connected to the slider member 102, the pair of positioning projections 103a, 103b are inserted into the corresponding pair of positioning holes

5a, 5b located on the front surface of the ink cartridge 1, and the pair of cartridge-side positioning surfaces 24a, 24b shown in FIG. 4(d) come into contact with the pair of apparatus-side positioning surfaces 104a, 104b.

Turning now to the pair of positioning holes 5a, 5b, the pair of positioning projections 103a, 103b, the pair of cartridge-side positioning surfaces 24a, 24b, and the pair of apparatus-side positioning surfaces 104a, 104b, it is preferable for one positioning hole 5a, one positioning projection 103a, one cartridge-side positioning surface 24a, and one apparatus-side positioning surface 104a to have a function of positioning the ink cartridge 1 in relation to the slider member 102 more precisely. Especially, positioning of the ink cartridge 1 in the inserting direction is precisely performed by the cartridge-side positioning surface 24a and the apparatus-side positioning surface 104a.

As is clear from FIGS. 2D, 4B and 4D, the positioning holes 5a and 5b are preferably arranged so that lines passing perpendicularly through those holes themselves lie in a plane P1 that is parallel to the bottom of the ink cartridge, and the bottom groove (more specifically, flat floors of portions 19b, 19c, 21c in this embodiment) of the ink cartridge-side fixing structure.

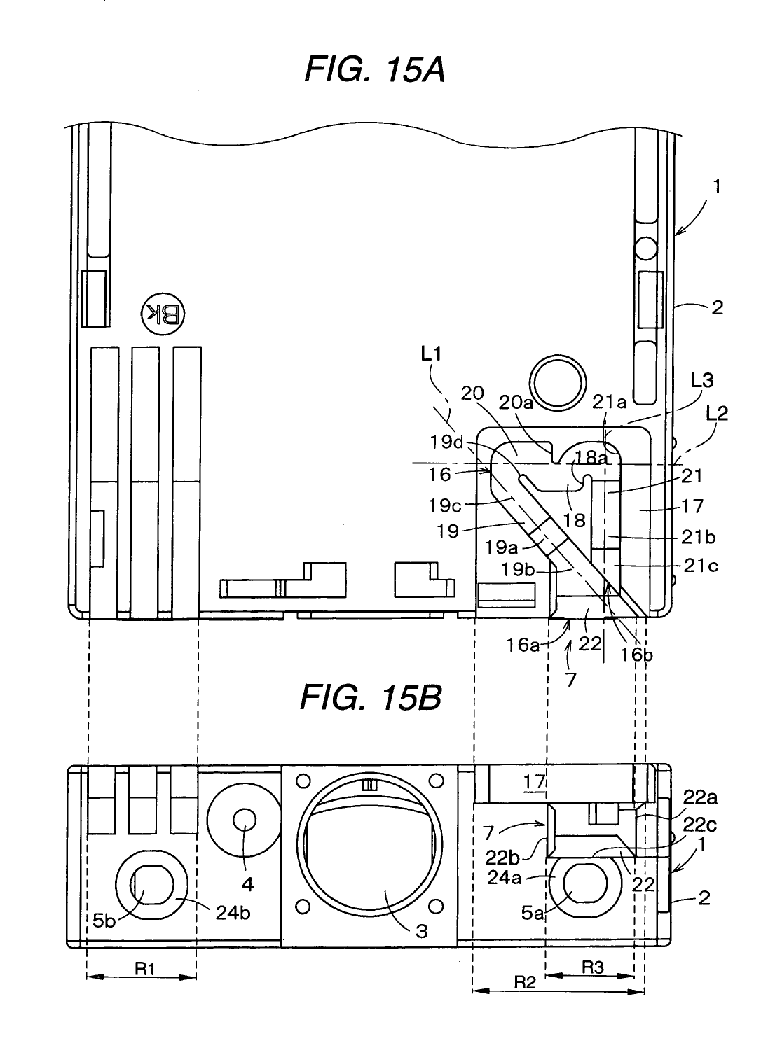

Also, with reference to FIGS. 2D, 4B-D and 15A-B, it will be recognized that the positioning holes are overlapped by the imaginary extensions (or projections) of the adjoining cartridge-side fixing structure 7 and erroneous mount preventing structure 6. That is, in this embodiment, as shown in FIG. 15B, the positioning hole 5b is disposed within a region R1 defined by the erroneous mount preventing structure 6, and the positioning hole 5a is disposed within a region R2 defined by the cartridge-side fixing structure 7. Further, in this embodiment, as shown in FIG. 15B, the positioning hole 5a is disposed within a region R3 defined by parallel edges 22a and 22b of an open section 22a, 22b, 22c of the front surface of the ink cartridge.

As apparent from FIG. 4B, the positioning hole 5a and the cartridge-side positioning surface 24a that are used for precise positioning are arranged near the memory unit 8 including the electrode 8a. This way, the positioning hole 5a, the cartridge-side positioning surface 24a and the cartridge-side fixing structure 7 are arranged in the vicinity of the memory unit 8.

Further, the positioning hole 5a and the cartridge-side fixing structure 7 are arranged so that the positioning projection 103a inserted into the positioning hole 5a, and the cartridge-side fixing structure 7 are superimposed on each other in the thickness direction of the container body 2. As a result, the memory unit can be positioned relative to the corresponding contact structure of the printer with improved accuracy.

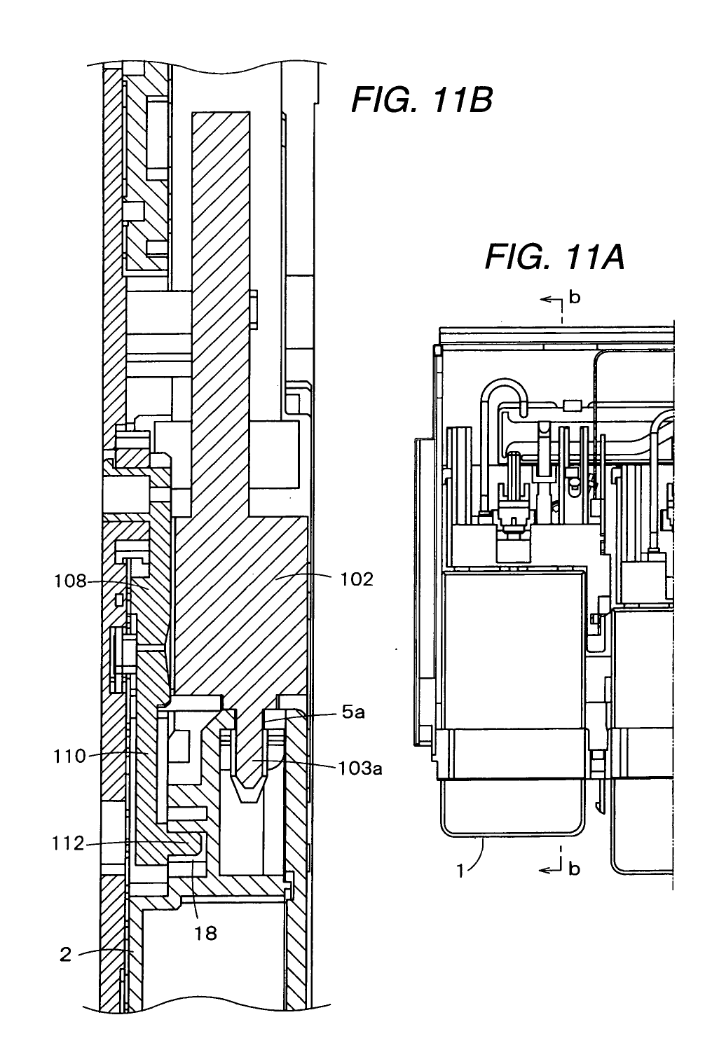

FIGS. 11A and 11B show respectively a state where the ink cartridge 1 is precisely positioned with respect to the slider member 102 by the positioning hole 5a, the positioning projection 103a, the cartridge-side positioning surface 24a and the apparatus-side positioning surface 103a. A fixing pin 112 of the apparatus-side fixing structure 107 is inserted and held in a fixing part 18 of a guide groove 16 of the container body 2.

Further, as shown in FIGS. 9 and 10, a pressure fluid port 105 to be connected to the pressure fluid inlet 4 of the ink cartridge 1 is provided on the surface of the slider member 102 opposed to the front surface of the ink cartridge.

Further, as shown in FIGS. 9 and 10, a contact protrusion part 114 having an apparatus-side contact 113 to be connected to the electrode 8a of the memory unit 8 is provided at one end of the front surface of the slider member 102,

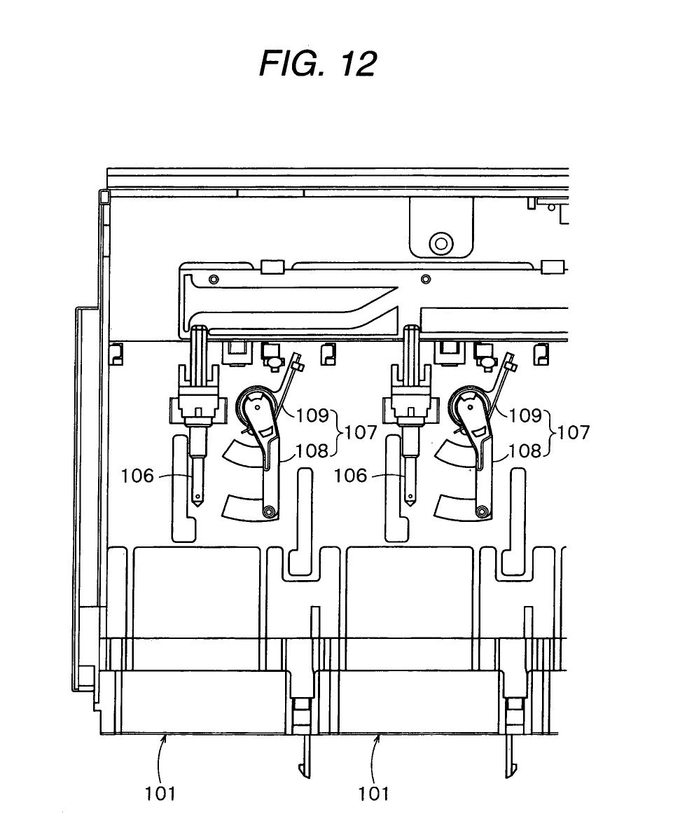

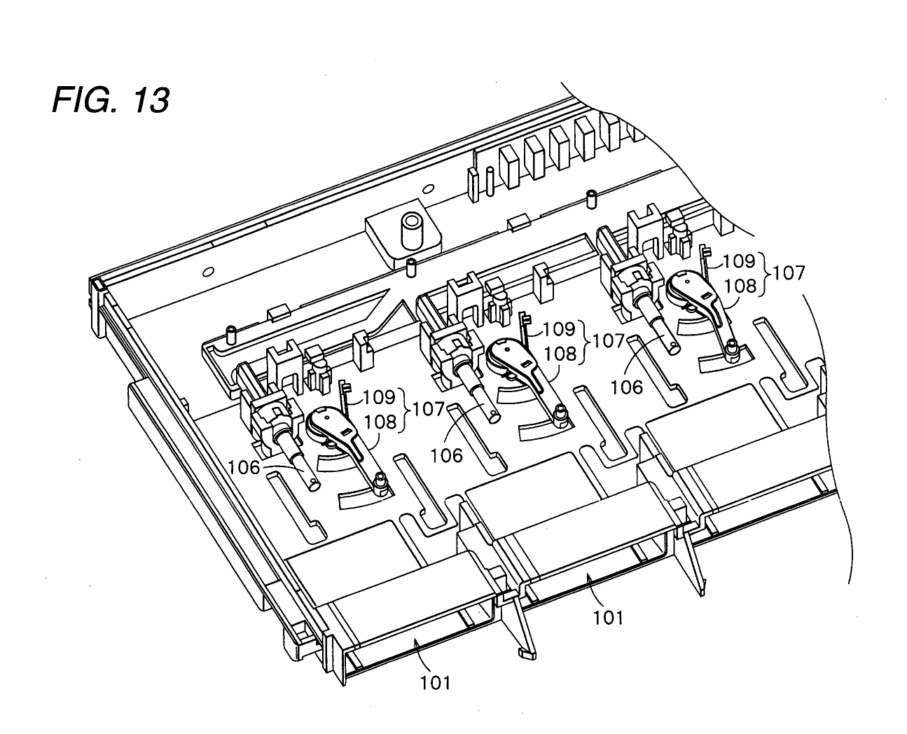

FIGS. 12 and 13 show respectively a state where the slider member 102 is removed from the cartridge mounting part 101. An ink supply needle 106 is secured inside the cartridge mounting part 101. The ink cartridge 1 is pushed in together with the slider member 102, whereby the ink supply needle 106 is inserted into the ink supply port 3 of the ink cartridge 1.

It should be understood that the ink supply port 3 is in communication with the interior of the ink cartridge 1. By this it is meant that there is fluid communication between the ink supply port 3 and a region inside the ink cartridge 1, such as the interior of the ink bag 9 contained therein. Such communicating also would cover a structure where the ink bag is omitted and the ink supply port has access directly to the interior of the ink cartridge.

Further, inside the cartridge mounting part 101, the apparatus-side fixing structure 107 is provided, which regulates releasably the movement of the ink cartridge 1 in the pulling direction in cooperation with the cartridge-side fixing structure 7.

The apparatus-side fixing structure 107 has a turn lever member 108. This turn lever member 108 is supported rotatably about its base end part so that it can pivot thereabout, and is urged by a spring member 109 in one rotating direction (counterclockwise for the structure depicted in FIG. 12).

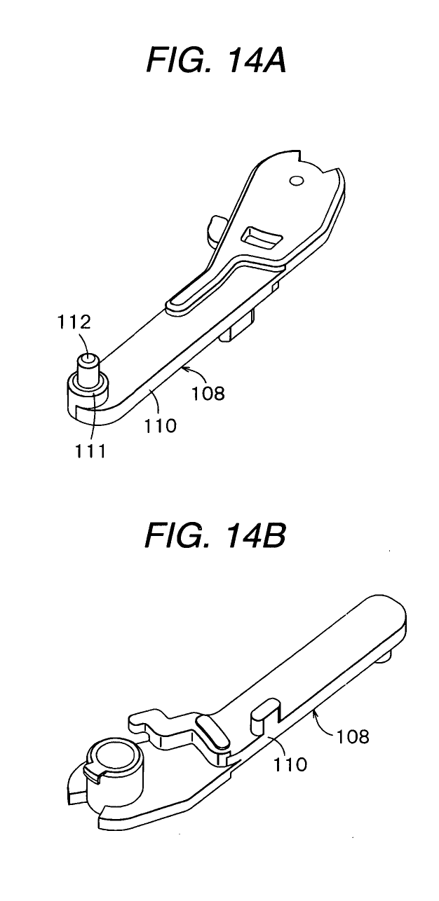

As shown in FIG. 14, the turn lever member 108 comprises an elongate lever body 110, an approximately cylindrical pin attaching part 111 provided at a leading end of this lever body 110, an approximately cylindrical fixing pin 112 which is provided on a top surface of this pin attaching part 111 and which is smaller in diameter than the pin attaching part 111.

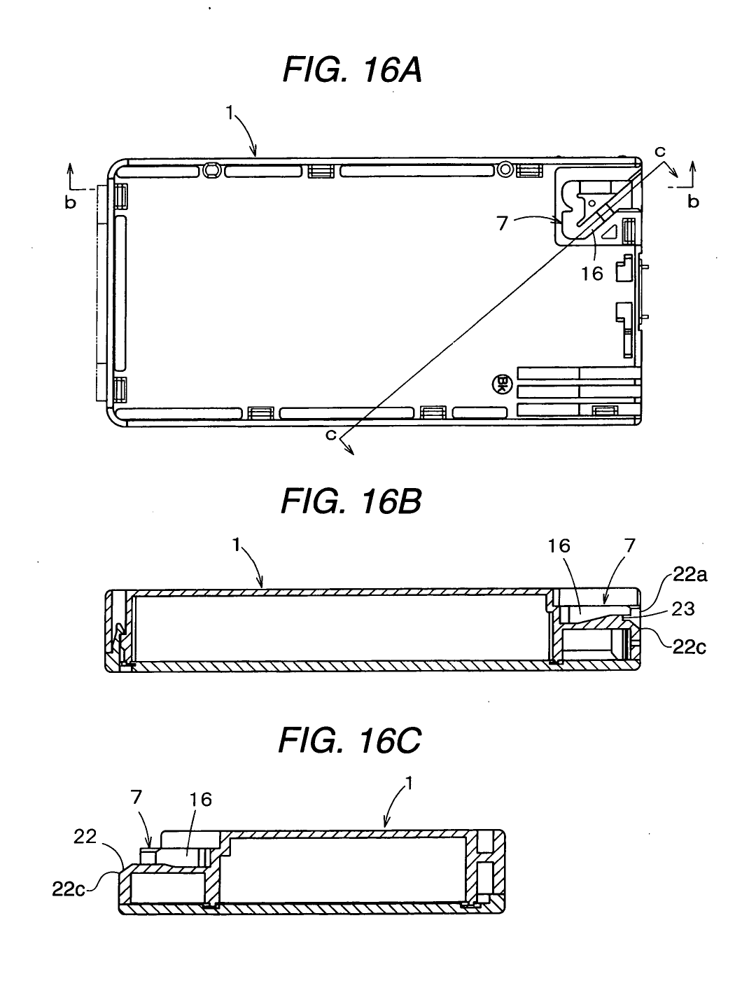

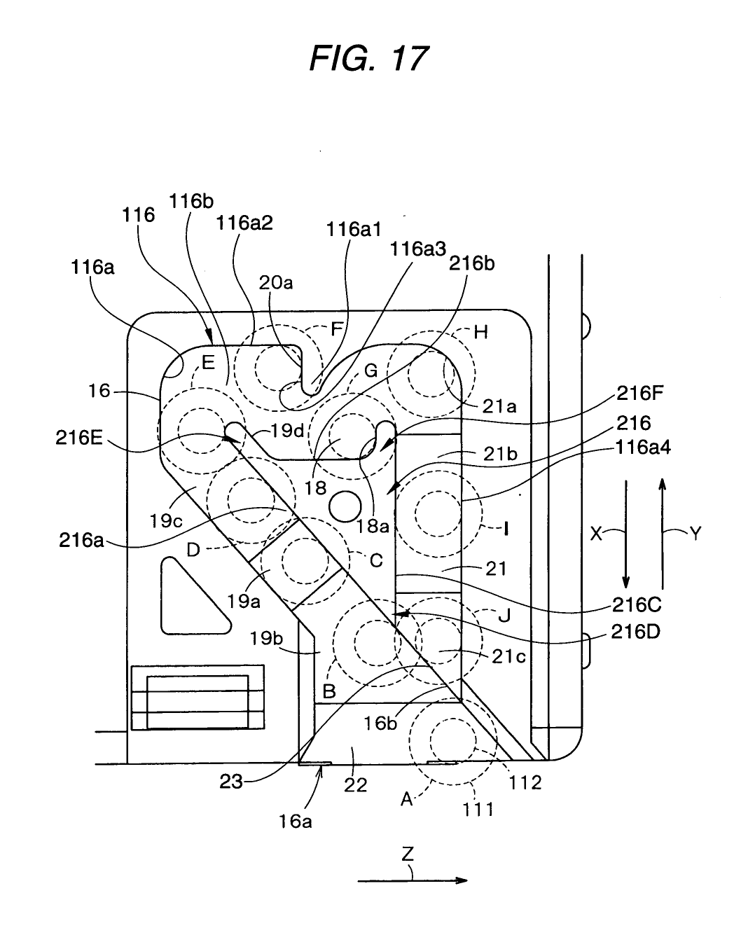

As shown in FIGS. 15 and 16, the cartridge-side fixing structure 7 is composed of the guide groove 16 having a rectangular section, into which the fixing pin 112 is inserted. In other words, to define a guide path (i.e., the guide groove 16 in this embodiment) having such a width as to permit the fixing pin 112 to pass therethrough, and therealong, a recess 116 having a perimeter wall 116a and a bottom 116b is provided to the bottom surface of the ink cartridge, and a guide projection 216 is disposed within the recess 116 so that the guide projection 216 protrudes from the bottom 116b of the recess 116 toward the bottom surface of the ink cartridge, as shown in FIG. 17. The guide projection 216 has three edges 216a, 216b and 216c. Accordingly, the guide path (i.e., the guide groove 16 in this embodiment) is defined by the perimeter wall 116a and bottom 116b of the recess 116 and the edges 216a, 216b and 216c of the guide projection 216. As shown in FIG. 17, the guide projection 216 has a generally-triangular shape with three vertices 216d, 216e and 216f. The vertex 216f, preferably each of the vertices 216e and 216f, is formed as an outward-extending projection as shown in FIG. 17. A portion of the perimeter wall 116a of the recess 116 has a projection 116a1 extending toward the guide projection 216.

A recess part 17 is formed at a corner on the cartridge rear surface near the positioning hole 5a and the cartridge-side positioning surface 24a which are used for positioning the cartridge with high accuracy. The guide groove 16 is provided in a recessed manner at the bottom of this recess part 17. The bottom surface of this guide groove 16 is made perpendicular to the side surface of the container body 2 on which the memory unit 8 is arranged.

In mounting and removal operations of the ink cartridge 1 to and from the cartridge mounting part 101, the fixing pin 112 of the turn lever member 108 of the apparatus-side fixing structure 107 is guided by the guide groove 16 of the cartridge-side fixing structure 7.

The guide groove 16 includes the fixing part 18 to which the fixing pin 112 is engaged in the state where the ink cartridge 1 is mounted to the cartridge mounting part 101 and which regulates the movement of the ink cartridge 1 in the pulling direction. The fixing part 18 is mainly defined by the edge 216b including a left half of the outward-extending projection 216F as shown in FIG. 17.

Further, the guide groove 16 includes an entrance-side guide part 19 which guides the fixing pin 112 when the ink cartridge 1 is inserted into the cartridge mounting part 101; an intermediate guide part 20 which leads the fixing pin 112 to the fixing part 18 when the ink cartridge 1 that has been inserted into the cartridge mounting part 101 is pushed backward in the pulling direction; and an exit-side guide part 21 which guides, to the exit of the guide groove 16, the fixing pin 112 released from the fixing part 18 by pushing the ink cartridge 1 in the insertion direction when the ink cartridge 1 is removed from the cartridge mounting part 101.

The entrance-side guide part 19 is mainly defined by the edge 216a. The intermediate guide part 20 is mainly defined by portions 116a2 and 116a3 of the perimeter wall 116a, the portion 116a3 being a left half of the projection 116a1 as shown in FIG. 17. The exit-side guide part 21 is mainly defined by a portion 116a4 of the perimeter wall 116a, the portion 116a4 opposing the edge 216c of the guide projection 216.

A main portion (linear portion) of the entrance-side guide part 19 of the guide groove 16 is provided to extend at an angle of about 30° to 50° relative to the inserting/pulling direction. Further, an end of the entrance-side guide part 19 is formed to present a curved shape by a projection-shaped wall part 19d (216e).

Further, an entrance slant surface 22 is formed at an entrance part 16a of the guide groove 16. This entrance slant surface 22 slants so that a groove depth becomes shallower in the moving direction of the fixing pin 112 that relatively moves in association with the inserting operation of the ink cartridge 1 into the cartridge mounting part 101.

A width (R3 in FIG. 15B) of the entrance slant surface 22 is set larger than a groove width of the main portion of the guide groove 16 including the fixing part 18 and being formed with the nearly same width. Further, the width of the entrance slant surface 22 is set larger than the diameter of the pin attaching part 111 to which the fixing pin 112 is attached. On the other hand, the groove width of the main portion of the guide groove 16 is set smaller than the diameter of the pin attaching part 111.

Further, a deep groove forming slant surface 19a is formed at the entrance-side guide part 19 between the entrance slant surface 22 and the fixing part 18, which slant surface 19a slants so that the guide groove 16 becomes deeper in the moving direction of the fixing pin 112 that relatively moves in association with the inserting operation of the ink cartridge 1 into the cartridge mounting part 101. A flat part 19b is formed between this deep groove forming slant surface 19a and the entrance slant surface 22. Further, a flat part 19c is formed, continuing from the deep groove forming slant surface 19a.

The depth of the guide groove 16 at the shallowest part formed by the entrance slant surface 22, that is, the groove depth of the flat part 19b is smaller than the length of the fixing pin 112. Further, the depth of the guide groove 16 at the deepest part formed by the deep groove forming slant surface 19a, that is, the groove depth of the flat part 19c is larger than the length of the fixing pin 112.

Further, the intermediate guide part 20 of the guide groove 16 includes a temporarily stopping side wall part 20a which stops temporarily the fixing pin 112, moving in the direction of the fixing part 18, in front of the fixing part 18 when the ink cartridge 1 has been inserted into the cartridge mounting part 101 to a sufficient depth. The side wall part 20a corresponds to the portion 116a3 of the perimeter wall 116a.

Further, the fixing part 18 of the guide groove 16 includes a final stopping side wall part 18a which receives and stops in a predetermined position the fixing pin 112 that has been released from the temporarily stopping side wall 20a and moves to the fixing part 18 when the ink cartridge 1 inserted into the cartridge mounting part 101 to a sufficient depth is pushed back in the pulling direction, thereby stopping the fixing pin 112. The side wall part 18a corresponds to the left half of the projection 216f.

Further, a curved side wall part 21a is formed at a start end of the exit-side guide part 21, a linear slant surface 21b is formed continuing from this curved side wall part 21a, and further, a linear flat part 21c is formed continuing from the slant surface 21b.

Accordingly, guide groove 16 includes a flat first floor section corresponding to the flat part 19b and leading to a sloped second floor section corresponding to the slant surface 19a and leading to a flat third floor section corresponding to the end portion of the entrance-side guide part 19, the intermediate guide part 20, the fixing part 18 and the beginning portion of the exit-side guide part 21 and leading to a sloped fourth floor section corresponding to the slant surface 21b and leading to a flat fifth floor section corresponding to the flat part 21c. As shown in FIG. 15A, the first and second floor sections are disposed along a first line L1, a portion of the third floor section corresponding to the parts 20 and 18 and the beginning portion of the part 21 is approximately disposed along a second line L2, and the fourth and fifth floor sections are disposed along a third line L3. The second and third lines L2, L3 intersect at a right angle. In addition, the bottom of the guide groove 16, corresponding to the first, third and fifth floor sections, is in parallel to the bottom surface of the ink cartridge.

Further, an exit part 16b of the guide groove 16 is connected to the entrance part 16a, whereby the guide groove 16 forms a loop as a whole. In the connection part between the entrance part 16a and the exit part 16b, the groove depth of the exit part 16b is shallower than the groove depth of the entrance part 16a, whereby a step part 23 (shown in FIG. 16B) is formed at the connection part. This step part 23 prevents the fixing pin 112 from entering the flat part 21c when the ink cartridge 1 is inserted into the cartridge mounting part 101.

Next, the operation of the fixing pin 112 into the guide groove 16 in the mounting and removal operation of the ink cartridge 1 will be described with reference to FIG. 17. It should be understood that arrow Z in FIG. 17 represents an urging direction of the turn lever member 108 resulting from the biasing action of the spring member 109.

After the ink cartridge 1 has inserted into the cartridge mounting part 101 and connected to the slider member 102, when the ink cartridge 1 is further pushed in the insertion direction X against the urging force of the slider member 102, the fixing pin 112 of the turn lever member 108 is inserting into the entrance part 16a of the guide groove 16 (position A in FIG. 17) through the open section 22a, 22b, 22c of the front surface of the ink cartridge.

Since the entrance slant surface 22 is formed at the entrance part 16a of the guide groove 16, the fixing pin 112, sliding on this entrance slant surface 22, moves in the opposite direction to the groove depth direction. Hereby, the turn lever member 108 or a member supporting the turn lever member 108 deforms elastically, so that force urging the fixing pin 112 toward the bottom surface of the guide groove 16 is produced.

When the leading end of the fixing pin 112 firstly comes into contact with the entrance slant surface 22, the top surface of the pin attaching part 111 is located in the lower position than the edge level of the guide groove 16. While the fixing pin 112 moves on the entrance slant surface 22, the groove depth changes so that the top surface of the pin attaching part 111 exceeds the edge level of the guide groove 16.

When the fixing pin 112 passes through the entrance slant surface 22 and next gets over the flat part 19b (position B in FIG. 17), only the fixing pin 112 is inserted into the guide groove 16, and the pin attaching part 111 is located outside the guide groove 16. This is because the depth of the guide groove 16 at the flat part 19b is set smaller than the length of the fixing pin 112.

By thus providing the entrance slant surface 22 for the entrance part 16a of the guide groove 16, it is possible to prevent, when the fixing pin 112 is inserted into the entrance part 16a of the guide groove 16, the fixing pin 112 from being caught by the front surface of the ink cartridge 1, so that the insertion of the fixing pin 112 into the entrance part 16a of the guide groove 16 can be performed smoothly and surely.

Further, since the entrance slant surface 22 is formed and the groove depth of the flat part 19b continuing from this surface 22 is set smaller than the length of the fixing pin 112, even in case that the width of the entrance part 16a of the guide groove 16 is set large and the width of the groove continuing from this part 16a is made narrow like that in the embodiment, the pin attaching part 111 is not caught in the narrow-width part of the guide groove 16. By setting the width of the entrance part 16a of the guide groove 16 large, the fixing pin 112 can be inserted into the guide groove 16 surely.

When the ink cartridge 1 is further pushed in the inserting direction X, the fixing pin 112 passes through the flat part 19b, and moves in the groove depth direction (position C in FIG. 17), sliding on the deep groove forming slant surface 19a.

When the fixing pin 112 passes through the deep groove forming slant surface 19a and comes to the position of the flat part 19c (position D in FIG. 17), the peripheral edge part of the top surface of the pin attaching part 111 fits to the edge part of the guide groove 16 and is pressed against this edge part. This is because of the continuing elastic deformation produced in the turn lever member 108 when the fixing pin 112 passes through the entrance slant surface 22 and which is still present at this time. By thus fitting the peripheral edge part of the top surface of the pin attaching part 111 to the edge part of the guide groove 16, it is possible to prevent the turn lever member 108 from coming into contact with the surface including the edge part of the guide groove 16 (bottom surface of the recess part 17), thereby preventing the fixing pin 112 from rising out of the guide groove 16.

Further, when the fixing pin 112 comes to the position of the flat part 19c (position D in FIG. 17), the leading end of the fixing pin 112 is separated from the bottom surface of the guide groove 16. This is because the groove depth of the flat part 19c is set larger than the length of the fixing pin 112.

When the ink cartridge 1 is further pushed in the inserting direction X, and the fixing pin 112 exceeds the position (position E in FIG. 17) near the leading end of the projection-like wall part 19d located at the end of the entrance-side guide part 19, the fixing pin 112 moves in the direction Z by the urging force of the spring member 109. Then, the fixing pin 112 strikes the temporarily stopping side wall 20a and stops (position F in FIG. 17). At this time, an audible click is produced. Upon hearing this click, the user is able to confirm that the ink cartridge 1 has been inserted to sufficient depth.

When the user stops pressing the ink cartridge 1 in the inserting direction X, the ink cartridge 1 is pushed back slightly in the pulling direction Y (that is, toward the user) by the urging force of the slider member 102. Hereby, engagement of the fixing pin 112 to the temporarily stopping side wall 20a is released, and the fixing pin 112 moves in the direction Z in response to the urging force of the spring member 109. Then, the fixing pin 112 collides with the lastly stopping side wall 18a and stops in the fixing position (position G in FIG. 17), and an audible click is produced at this time. By hearing this click, the user can confirm that the ink cartridge 1 has been properly fixed to the cartridge mounting part 101.

Here, the depth of the groove in the fixing part 18 of the guide groove 16 is set larger than the length of the fixing pin 112 similarly to that in the flat part 19c of the entrance-side guide part 19. Further, by the elastic deformation of the turn lever member 108 produced when the fixing pin 112 passes through the entrance slant surface 22, the fixing pin 112 is urged toward the bottom surface of the guide groove 16.

Therefore, regarding the fixing pin 112 fixed in the predetermined fixing position of the stopping part 18, its full length enters into the inside of the guide groove 16, and the peripheral edge part of the top surface of the pin attaching part 111 fits against the edge part of the guide groove 16. Hereby, this fitting against the side wall of the guide groove 16 can serve to prevent the fixing pin 112 (particularly, its base part) from experiencing creep resulting from the force applied to the fixing pin 112. Namely, in case that the fixing pin 112 is caught in the guide groove 16 shallowly, the force applied to the base part of the fixing pin 112 increases by the principle of levers. However, in the embodiment, since the fixing pin 112 is caught in the guide groove 16 throughout its full length as described above, the creep of the fixing pin 112 can be prevented.

Further, since the fixing pin 112 is caught in the guide groove 16 deeply enough, the fixing pin 112 never comes out of the guide groove 16. This effect is not limited to only the fixing part 18 but is obtained also while the fixing pin 112 is relatively moving in the guide groove 16 in case that the peripheral edge part of the top surface of the pin attaching part 111 slides along the edge part of the guide groove 16.

Further, the fixing pin 112 is urged toward one side surface of the ink cartridge 1 by the spring member 109, and the electrode 8a of the memory unit 8 is provided on this side surface. Therefore, the urging force of the spring member 109 acts through the fixing pin 112 and the lastly stopping side wall part 18a so that the electrode 8 of the memory unit 8 is pressed toward the apparatus-side contact 113 (FIGS. 9 and 10). Hereby, it is possible to secure the connections between the electrode 8a of the memory unit 8 and the apparatus-side contact 113.

Next, when the ink cartridge 1 is removed from the cartridge mounting part 101, the ink cartridge 1 is pushed slightly in the inserting direction X by the user. Then, engagement of the fixing pin 112 with the lastly stopping side wall 18a is released, and the fixing pin 112 moves in the direction Z in response to the urging force exerted by the spring member 109, Next, the fixing pin 112 collides with the curved side wall 21a of the exit-side guide part 21 of the guide groove 16 and temporarily stops (position H in FIG. 17). At this time, an audible click is produced. By hearing the click, the user can confirm that fixing of the ink cartridge 1 to the cartridge mounting part 101 has been released.

Next, the user stops pressing the ink cartridge 1 in the inserting direction X. When the ink cartridge 1 moves in the pulling direction Y in response to the urging force of the slider member 102, the fixing pin 112 moves along the linear slant surface 21b of the exit-side guide part 21 (position I in FIG. 17). At this time, the leading end of the fixing pin 112 comes into contact with the slant surface 21b in the middle of the slant surface 21b, and the fixing pin 112 moves upward in the opposite direction to the groove depth direction. The fixing pin 112 that has passed through the slant surface 21b passes through the flat part 21c (position J in FIG. 17) and out from the exit part 16b of the guide groove 16.

Next, a connection process of the ink cartridge 1 to the ink supply needle 106, etc. when the ink cartridge 1 is mounted to the cartridge mounting part 101 will be described.

When the ink cartridge 1 is inserted into the cartridge mounting part 101, firstly, the positioning projections 103a, 103b of the slider member 102 are inserted into the positioning holes 5a, 5b of the ink cartridge 1. Further, the pressure fluid port 105 of the slider member 102 is connected to the pressure fluid inlet 4 of the ink cartridge 1. Further, the electrode 8a of the memory unit 8 and the apparatus-side contact 113 are connected to each other, whereby electrical communication can be established.

The electrode 5a of the memory unit 8 and the apparatus-side contact 113 establish electrical communication before the ink supply needle 106 has been inserted into the ink supply port 3 of the ink cartridge. Accordingly, the data is read from the memory unit 8 at this time, and a determination is made whether the proper ink cartridge 1 has been inserted. If the wrong ink cartridge 1 has been inserted, then before the ink supply needle 106 is inserted into the ink supply port 3 of the wrong ink cartridge 1, there is an opportunity to replace the wrong ink cartridge with the proper ink cartridge. Hereby, it is possible to prevent the wrong type of ink from flowing into the ink flowing path of the apparatus body. Further, in this situation, when the ink supply port 3 of the ink cartridge 1 that has been inserted wrongly is sealed by a seal, it is possible to avoid breaking the seal unnecessarily.

After the ink cartridge 1 has been connected to the slider member 102, the ink cartridge 1 is further pushed in the inserting direction X against the urging force of the slider member 102, whereby the ink supply needle 106 is inserted into the ink supply port 3 of the ink cartridge 1.

Next, a separation process for disengaging the ink cartridge 1 from the ink supply needle 106 when the ink cartridge 1 is detached from the cartridge mounting part 101 will be described.

As described above, by pushing the ink cartridge 1 inward in the inserting direction X, fixing of the ink cartridge 1 by the cartridge-side fixing structure 7 and the apparatus-side fixing structure 107 is released, and the ink cartridge 1 can move in the pulling direction Y. The ink cartridge, released and no long fixed in position, moves firstly in the pulling direction Y together with the slider member 102, and the ink supply needle 106 comes out from the ink supply port 3 as a result of this movement.

When the ink supply needle 106 thus comes out from the ink supply port 3, since the connection between the electrode 8a of the memory unit 8 and the apparatus-side contact 113 is still maintained, data can be exchanged between the memory unit 8 and the apparatus body. Even though the ink cartridge has been released, data can be exchanged between the memory unit 8 of the cartridge 1 and the apparatus body, so that data transmission errors can be prevented.

When the ink cartridge is further moved in the pulling direction Y, the slider member 102 reaches a position in the predetermined position at which it becomes unmovable. When the ink cartridge 1 is further moved in the pulling direction Y from this state, the pressure fluid port 105 is separated from the pressure fluid inlet 4 of the ink cartridge 1, and the positioning projections 103a, 103b come out of the positioning holes 5a, 5b of the ink cartridge 1. Further, the electrode 8 of the memory unit 8 and the apparatus-side contact 113 are disconnected.

As described above, the ink cartridge 1 according to the embodiment can be mounted to the cartridge mounting part 101 of the ink jet type recording apparatus 100 readily and surely.

Particularly, in the ink cartridge 1 according to the embodiment, since the width of the entrance slant surface 22 formed at the entrance part 16a of the guide groove 16 can be made large, the insertion of the fixing pin 112 into the guide groove 16 can be surely performed. Since the turn lever member 108 including the fixing pin 112 is constructed so as to swing in the direction Z perpendicular to the inserting and pulling directions X, Y of the ink cartridge 1, variations may be produced in the initial position (the position in a state where the ink cartridge has not been mounted yet) of the fixing pin 112. However, by making the width of the entrance slant surface 22 large, these variations can be accommodated.

Further, in the ink cartridge 1 according to the embodiment, it is possible to complete the mounting operation by only one operation (single push operation) that the ink cartridge 1 is inserted into the cartridge mounting part 101. On the other hand, when the ink cartridge 1 is removed from the cartridge mounting part 101, the fixing state of the ink cartridge 1 can be released by only the easy operation that the ink cartridge 1 is slightly pushed in. In the embodiment, it is possible to perform the mounting and removal operations of the ink cartridge 1 very readily like this.

Further, in the ink cartridge 1 according to this embodiment, since the guide groove 16 is formed on the bottom surface of the recess part 17 formed on the surface of the cartridge, in the state where the fixing pin 112 is inserted into the guide groove 16, the protruding amount of the turn lever member 108 from the cartridge surface can be reduced or even made zero. Therefore, the thickness of the cartridge mounting part 101 can be reduced, so that the size the ink jet type recording apparatus 100 can be decreased. Particularly, in the case of an apparatus of the type in which the plural ink cartridges 1 are arranged in a flat and juxtaposed manner such as the ink jet type recording apparatus 100 shown in FIG. 1, it is desirable to reduce the thickness of the whole of the apparatus. Therefore, the ink cartridge 1 according to the embodiment, which can reduce the thickness of the cartridge mounting part 101, is very effective and helpful to achieving this goal.

Further, in the ink cartridge 1 according to the embodiment, since the memory unit 8 including the electrode 8a is arranged near the cartridge-side fixing structure 7, the electrode 8a of the memory unit 8 can be surely and securely connected to the apparatus-side contact 113 of the cartridge mounting part 101.

Particularly, since the urging force of the spring member 109 acts so as to press the electrode 8a of the memory unit 8 in the direction of the apparatus-side contact 113 of the cartridge mounting part 101 through the fixing pin 112 and the lastly stopping side wall 18a, the electrode 8 of the memory unit 8 can be surely connected to the apparatus-side contact 113.

Further, since the cartridge-side fixing structure 7 and the memory unit 8 including the electrode Ba are arranged at a position near the ink supply port 3 of the whole of the container body 2, the connection of the electrode 8 of the memory unit 8 to the apparatus-side contact 113 can be more surely performed.

Further, the memory unit 8, including the electrode 8a, is arranged near the cartridge-side fixing structure 7, and the positioning hole 5a and the cartridge-side positioning surface 24a that are used for accurate positioning. Therefore, the connection of the electrode 8 of the memory unit 8 to the apparatus-side contact 113 can be more surely performed.

1. An ink cartridge, comprising:
a container body having a surface, the surface having a recess, the recess having a bottom and a perimeter wall;
a guide projection disposed within the recess, at least a portion of said guide projection extending from the bottom of the recess toward the surface, wherein, viewing the guide projection in a direction perpendicular to the bottom of the recess, the guide projection has at least three edges;
wherein said perimeter wall and said edges of said guide projection define a path therebetween, and the path has at least a predetermined width.

2. The ink cartridge as in claim 1, wherein, viewing the guide projection in a direction perpendicular to the bottom of the recess, the guide projection has a generally-triangular shape with three vertexes.

3. The ink cartridge as in claim 2, wherein, viewing the guide projection in a direction perpendicular to the bottom of the recess, at least one of the vertexes includes an outward-extending projection.

4. The ink cartridge as in claim 3, wherein a portion of the perimeter wall has a projection arranged so that the predetermined width of the path is maintained between the projection and the outward-extending projection.

5. The ink cartridge as in claim 4, wherein, viewing the guide projection in a direction perpendicular to the bottom of the recess, the projection extends toward the guide projection.

6. The ink cartridge as in claim 1, wherein the path defines a loop.

7. An ink cartridge, comprising:
a container body having a surface, the surface having a recess, the recess having a bottom, and a perimeter wall;
a guide projection disposed within the recess, at least a portion of said guide projection extending from the bottom of the recess toward the surface,
wherein said perimeter wall and said guide projection define a path therebetween, the path having a flat first floor section leading to a sloped second floor section leading to a flat third floor section leading to a sloped fourth floor section leading to a flat fifth floor section.

8. The ink cartridge of claim 7, wherein the flat first, third and fifth floor sections lie in parallel planes.

9. The ink cartridge of claim 7, wherein the flat first floor section and the sloped second floor section are disposed along a first line, and the flat third floor section is approximately disposed along a second line, and the first and second lines intersect.

10. The ink cartridge of claim 9, wherein the sloped fourth floor section and the flat fifth floor section are disposed along a third line, and the second and the third lines intersect.

11. The ink cartridge of claim 9, wherein the intersecting first, second and third lines define a triangle.

12. The ink cartridge of claim 11, wherein the second and the third lines intersect at a right angle.

13. The ink cartridge of claim 10, wherein the path defines a loop.

14. An ink cartridge, comprising:
a container body having a front surface having a first opening extending inward into the ink cartridge along a first line and a second opening extending inward into the ink cartridge along a second line approximately parallel to the first line, and a bottom surface, the bottom surface having a recess, the recess having a bottom and a perimeter wall; and
a guide projection disposed within the recess, at least a portion of said guide projection extending from the bottom of the recess toward the bottom surface,
wherein, viewed in a direction perpendicular to the front surface, the first and the second lines lie in a plane parallel to at least a portion of the bottom surface and at least a portion of the bottom of the recess is parallel to the plane.

15. The ink cartridge of claim 14, wherein, viewed in the direction perpendicular to the front surface, the front surface has an open section leading to the recess, the first opening is located closer to the open section than the second opening, the open section of the front surface having two vertical edges, the vertical edges lying in parallel first and second vertical planes, and the open section is positioned so that at least a part of the first opening is disposed between the parallel first and second vertical planes.

16. The ink cartridge of claim 15, wherein, viewed in the direction perpendicular to the front surface, the first line is disposed between the parallel first and second vertical planes.

17. An ink cartridge, comprising:
a container body having a front surface having a first opening extending inward into the ink cartridge along a first line and a second opening extending inward into the ink cartridge along a second line approximately parallel to the first line, and a bottom surface, the bottom surface having a recess, the recess having a bottom and a perimeter wall; and
a guide projection disposed within the recess, at least a portion of said guide projection extending from the bottom of the recess toward the bottom surface,
wherein, viewed in a direction perpendicular to the front surface, the first and the second openings lie in a plane parallel to at least a portion of the bottom surface and at least a portion of the bottom of the recess is parallel to the plane.

18. The ink cartridge of claim 17, wherein the guide projection and the perimeter wall define a path therebetween, and the path defines a loop.

19. An ink cartridge, comprising:
a generally-rectangular container body having an interior and a bottom surface, the bottom surface having a recess, the recess having a bottom and a perimeter wall, a front surface and a side surface, the bottom surface, the front surface and the side surface lying in respective intersecting perpendicular planes;
a guide projection disposed within the recess, at least a portion of said guide projection extending from the bottom of the recess toward the surface, wherein, viewing the guide projection in a direction perpendicular to the bottom of the recess, the guide projection has at least three edges;
an ink supply port communicating with the interior of the container body, the ink supply port being located in the front surface;
an air opening in fluid communication with the interior of the container, the air opening being located in the front surface; and
a first positioning hole and a second positioning hole, the first and second positioning holes being located in the front surface,
wherein said perimeter wall and said edges of said guide projection define a path therebetween, and the path has at least a predetermined width.

20. An ink cartridge as in claim 19, wherein the recess and one of the first and the second positioning holes are located proximate to a corner defined by the intersecting perpendicular planes.

21. An ink cartridge as in claim 19, further comprising a memory device having an electrode, the memory device being mounted on the side surface.

22. An ink cartridge as in claim 21, wherein the memory device, the recess and one of the first and the second positioning holes are located proximate to a corner defined by the intersecting perpendicular planes.

23. An ink cartridge as in claim 19, her comprising a grooved section located on the bottom surface, the grooved section having an arrangement of grooves that identifies a property of the ink cartridge.

24. An ink cartridge as in claim 19, further comprising a grooved section located on the bottom surface, the grooved section having an arrangement of grooves that identifies a property of the ink cartridge, and wherein, viewing the ink cartridge in a direction perpendicular to the bottom surface, imaginary extensions of the grooved section and the recess respectively overlap the first and the second positioning holes.

25. The ink cartridge as in claim 19, wherein, viewing the guide projection in a direction perpendicular to the bottom of the recess, the guide projection has a generally-triangular shape with three vertexes.

26. The ink cartridge as in claim 25, wherein, viewing the guide projection in a direction perpendicular to the bottom of the recess, at least one of the vertexes includes an outward-extending projection.

27. The ink cartridge as in claim 26, wherein a portion of the perimeter wall has a projection arranged so that the predetermined width of the path is maintained between the projection and the outward-extending projection.

28. The ink cartridge as in claim 27, wherein, viewing the guide projection in a direction perpendicular to the bottom of the recess, the projection extends toward the guide projection.

29. The ink cartridge as in claim 19, wherein the path defines a loop.

30. An ink cartridge, comprising:
a generally-rectangular container body having an interior and a bottom surface, the bottom surface having a recess, the recess having a bottom and a perimeter wall, a front surface and a side surface, the bottom surface, the front surface and the side surface lying in respective intersecting perpendicular planes;
a guide projection disposed within the recess, at least a portion of said guide projection extending from the bottom of the recess toward the surface;
an ink supply port communicating with the interior of the container body, the ink supply port being located in the front surface;
an air opening in fluid communication with the interior of the container, the air opening being located in the front surface; and
a first positioning hole and a second positioning hole, the first and second positioning holes being located in the front surface,
wherein said perimeter wall and said guide projection define a path therebetween, the path having a flat first floor section leading to a sloped second floor section leading to a flat third floor section leading to a sloped fourth floor section leading to a flat fifth floor section.

31. An ink cartridge as in claim 30, wherein the recess and one of the first and the second positioning holes are located proximate to a corner defined by the intersecting perpendicular planes.

32. An ink cartridge as in claim 30, further comprising a memory device having an electrode, the memory device being mounted on the side surface.

33. An ink cartridge as in claim 32, wherein the memory device, the recess and one of the first and the second positioning holes are located proximate to a corner defined by the intersecting perpendicular planes.

34. An ink cartridge as in claim 30, further comprising a grooved section located on the bottom surface, the grooved section having an arrangement of grooves that identifies a property of the ink cartridge.

35. An ink cartridge as in claim 30, further comprising a grooved section located on the bottom surface, the grooved section having an arrangement of grooves that identifies a property of the ink cartridge, and wherein, viewing the ink cartridge in a direction perpendicular to the bottom surface, imaginary extensions of the grooved section and the recess respectively overlap the first and the second positioning holes.

36. The ink cartridge of claim 30, wherein the flat first, third and fifth floor sections lie in parallel planes.

37. The ink cartridge of claim 30, wherein the flat first floor section and the sloped second floor section are disposed along a first line, and the flat third floor section is approximately disposed along a second line, and the first and second lines intersect.

38. The ink cartridge of claim 37, wherein the sloped fourth floor section and the flat fifth floor section are disposed along a third line, and the second and the third lines intersect.

39. The ink cartridge of claim 38, wherein the path defines a loop.

40. The ink cartridge of claim 38, wherein the intersecting first, second and third lines define a triangle.

41. The ink cartridge of claim 40, wherein the first and the second lines intersect at a right angle.

42. An ink cartridge, comprising:
a generally-rectangular container body having an interior, a bottom surface, the bottom surface having a recess, the recess having a bottom and a perimeter wall, a front surface having a first opening extending inward into the ink cartridge along a first line and a second opening extending inward into the ink cartridge along a second line approximately parallel to the first line, and a side surface, the bottom surface, the front surface and the side surface lying in respective intersecting perpendicular planes; and
a guide projection disposed within the recess, at least a portion of said guide projection extending from the bottom of the recess toward the bottom surface,
wherein, viewed in a direction perpendicular to the front surface, the first and the second lines lie in a plane parallel to at least a portion of the bottom surface and at least a portion of the bottom of the recess is parallel to the plane.

43. An ink cartridge as in claim 42, wherein the recess and one of the first and the second openings are located proximate to a corner defined by the intersecting perpendicular planes.

44. An ink cartridge as in claim 42, Her comprising a memory device having an electrode, the memory device being mounted on the side surface.

45. An ink cartridge as in claim 44, wherein the memory device, the recess and one of the first and the second openings are located proximate to a corner defined by the intersecting perpendicular planes.

46. An ink cartridge as in claim 42, further comprising a grooved section located on the bottom surface, the grooved section having an arrangement of grooves that identifies a property of the ink cartridge.

47. An ink cartridge as in claim 42, further comprising a grooved section located on the bottom surface, the grooved section having an arrangement of grooves that identifies a property of the ink cartridge, and wherein, viewing the ink cartridge in a direction perpendicular to the bottom surface, imaginary extensions of the grooved section and the recess respectively overlap the first and the second openings.

48. The ink cartridge of claim 42, wherein, viewed in the direction perpendicular to the front surface, the front surface has an open section leading to the recess, the first opening is located closer to the open section than the second opening, the open section of the front surface having two vertical edges, the vertical edges lying in parallel first and second vertical planes, and the open section is positioned so that at least a part of the first opening is disposed between the parallel first and second vertical planes.

49. The ink cartridge of claim 48, wherein, viewed in the direction perpendicular to the front surface, the first line is disposed between the parallel first and second vertical planes.

50. An ink cartridge, comprising:
a generally-rectangular container body having an interior, a front surface having a first opening extending inward into the ink cartridge along a first line and a second opening extending inward into the ink cartridge along a second line approximately parallel to the first line, and a bottom surface, the bottom surface having a recess, the recess having a bottom and a perimeter wall, the bottom surface, the front surface and the side surface lying in respective intersecting perpendicular planes; and
a guide projection disposed within the recess, at least a portion of said guide projection extending from the bottom of the recess toward the bottom surface,
wherein, viewed in a direction perpendicular to the front surface, the first and the second openings lie in a plane parallel to at least a portion of the bottom surface and at least a portion of the bottom of the recess is parallel to the plane.

51. An ink cartridge as in claim 50, wherein the recess and one of the first and the second openings are located proximate to a corner defined by the intersecting perpendicular planes.

52. An ink cartridge as in claim 50, further comprising a memory device having an electrode, the memory device being mounted on the side surface.

53. An ink cartridge as in claim 52, wherein the memory device, the recess and one of the first and the second openings are located proximate to a corner defined by the intersecting perpendicular planes.

54. An ink cartridge as in claim 50, further comprising a grooved section located on the bottom surface, the grooved section having an arrangement of grooves that identifies a property of the ink cartridge.

55. An ink cartridge as in claim 50, further comprising a grooved section located on the bottom surface, the grooved section having an arrangement of grooves that identifies a property of the ink cartridge, and wherein, viewing the ink cartridge in a direction perpendicular to the bottom surface, imaginary extensions of the grooved section and the recess respectively overlap the first and the second openings.

56. The ink cartridge of claim 50, wherein the guide projection and the perimeter wall define a path therebetween, and the path defines a loop.

57. An ink cartridge, comprising:
a generally-rectangular container body having an interior and a bottom surface, the bottom surface having a recess, the recess having a bottom surface and a perimeter wall, a front surface and a side surface, the bottom surface, the front surface and the side surface lying in respective intersecting perpendicular planes;
a guide projection disposed within the recess, at least a portion of said guide projection extending from the bottom of the recess toward the surface, wherein, viewing the guide projection in a direction perpendicular to the bottom surface of the recess, the guide projection has at least first, second and third edges;
an ink supply port communicating with the interior of the container body, the ink supply port being located in the front surface;
a first positioning hole and a second positioning hole, the first and second positioning holes being located in the front surface so that the ink supply port is located between the first and second positioning holes;
a memory device having an electrode, the memory device being mounted on the side surface, wherein:
the recess, the memory device and one of the first and second positioning holes are located proximate to a corner defined by the intersecting perpendicular planes;
said perimeter wall and said edges of said guide projection define a path therebetween, the path including an entrance-side guide part, an intermediate guide part, a fixing part, and an exit-side guide part;
the entrance-side guide part is defined at least in part by the first edge of the guide projection, the first edge of the guide projection being inclined relative to the front and side surfaces and perpendicular to the bottom surface;
the intermediate guide part is defined at least in part by first and second portions of the perimeter wall, the first portion of the perimeter wall being perpendicular to the side and bottom surfaces and parallel to the front surface, the second portion of the perimeter wall extending from the first portion of the perimeter wall toward the second edge of the guide projection, and being perpendicular to the bottom and front surfaces and parallel to the side surface;
the fixing part is defined at least in part by first and second portions of the second edge of the guide projection, the first portion of the second edge being perpendicular to the side and bottom surfaces and parallel to the front surface, the second portion of the second edge extending outwardly from the first portion of the second edge and being perpendicular to the bottom and front surfaces and parallel to the side surface;
the exit-side guide part is defined at least in part by third and fourth portions of the perimeter wall, the third portion of the perimeter wall being perpendicular to the bottom and side surfaces and parallel to the front surface, the fourth portion of the perimeter wall extending from the third portion of the perimeter wall along the third edge of the guide projection and being perpendicular to the bottom and front surfaces and parallel to the side wall;
an end of the entrance side guide part and an end of the exit-side guide part are connected together by a step.

58. An ink cartridge mountable to a mounting part of an ink-jet recording apparatus, the mounting part including a fixing pin, a first biasing member for applying a first biasing force to the pin in a first direction, and a second biasing member for applying a second biasing force to the ink cartridge, inserted into the mounting part in an insertion direction, in a second direction opposite from the insertion direction and perpendicular to the first direction, the ink cartridge comprising:
a generally-rectangular container body having an interior and a bottom surface, the bottom surface having a recess, the recess having a bottom surface and a perimeter wall, a front surface and a side surface, the bottom surface, the front surface and the side surface lying in respective intersecting perpendicular planes;
a guide projection disposed within the recess, at least a portion of said guide projection extending from the bottom of the recess toward the surface, wherein, viewing the guide projection in a direction perpendicular to the bottom surface of the recess, the guide projection has at least first, second and third edges;
an ink supply port communicating with the interior of the container body, the ink supply port being located in the front surface;
a first positioning hole and a second positioning hole, the first and second positioning holes being located in the front surface so that the ink supply port is located between the first and second positioning holes;
a memory device having an electrode, the memory device being mounted on the side surface, wherein;
the recess, the memory device and one of the first and second positioning holes are located proximate to a corner defined by the intersecting perpendicular planes;
said perimeter wall and said edges of said guide projection define a path therebetween for permitting the pin to pass therethrough, the path including an entrance-side guide part, an intermediate guide part, a fixing part, and an exit-side guide part;
the entrance-side guide part is defined at least in part by the first edge of the guide projection, the first edge of the guide projection being for guiding the pin against the first biasing force when the ink cartridge is inserted into the mounting part against the second biasing force;
the intermediate guide part is defined at least in part by first and second portions of the perimeter wall, the fist portion of the perimeter wall being for defining a first fully inserted position of the ink cartridge upon contact with the pin when the ink cartridge is inserted into the mounting part against the second biasing force, the second portion of the perimeter wall being for stopping the pin against the first biasing force when the ink cartridge is positioned at the first fully inserted position;
the fixing part is defined at least in part by first and second portions of the second edge of the guide projection, the first portion of the second edge being for holding the ink cartridge against the second biasing force upon contact with the pin when the ink cartridge is moved from the first fully inserted position to a predetermined fixing position by the second biasing force, the second portion of the second edge being for holding the pin against the first biasing force when the ink cartridge is moved from the first fully inserted position to the predetermined fixing position by the second biasing force;
the exit-side guide part is defined at least in part by third and fourth portions of the perimeter wall, the third portion of the perimeter wall being for defining a second fully inserted position of the ink cartridge upon contact with the pin when the ink cartridge is moved from the predetermined fixing position against the second biasing force, the fourth portion of the perimeter wall being for guiding the pin against the first biasing force and for moving the ink cartridge from the second fully inserted position using the second biasing force;
an end of the entrance side guide part and an end of the exit-side guide part are connected together by a step for preventing the pin from directly entering into the exit-side guide part and for guiding the pin into the entrance side guide part.
